(19) United States
(12) Patent Application Publication
(10) Pub. No.: US 2024/0209523 A1
(43) Pub. Date: Jun. 27, 2024

(54) ION-PAIR HT-PEMS FOR HYDROGEN SEPARATIONS USING ELECTROCHEMICAL PUMPING

(71) Applicant: Board of Supervisors of Louisiana State University and Agricultural and Mechanical College, Baton Rouge, LA (US)

(72) Inventors: Christopher George Arges, Baton Rouge, LA (US); Gokul Venugopalan, Baton Rouge, LA (US)

(21) Appl. No.: 18/557,613

(22) PCT Filed: May 11, 2022
(86) PCT No.: PCT/US2022/072239

§ 371 Date: Oct. 27, 2023

Related U.S. Application Data
(60) Provisional application No. 63/201,730, filed on May 11, 2021.
(60) Provisional application No. 63/192,607, filed on May 25, 2021.

(51) Int. Cl. C25B 9/23; B01D 53/32; C25B 1/02; C25B 11/032; C25B 11/052; C25B 11/054; C25B 11/065; C25B 11/081; C25B 13/08

(52) U.S. Cl. CPC C25B 9/23; B01D 53/326; C25B 1/02; C25B 11/032; C25B 11/052; C25B 11/054; C25B 11/065; C25B 11/081; C25B 13/08; B01D 2257/102; B01D 2257/108; B01D 2257/502; B01D 2257/504; B01D 2257/7025

(57) ABSTRACT

The present disclosure provides for electrochemical hydrogen pumps and methods of producing hydrogen. Embodiments provide for efficient and high yielding electrochemical hydrogen pumps that can operate at high temperatures here other pumps cannot operate effectively and an electrochemical hydrogen pump that can purify hydrogen from gas mixtures with large carbon monoxide compositions as other electrochemical hydrogen pumps technology cannot operate effectively with carbon monoxide in the gas mixture.

### CROSS-REFERENCE TO RELATED APPLICATIONS

This application claims the benefit of and priority to U.S. Provisional Application Ser. No. 63/201,730, having the title “HIGH TEMPERATURE ELECTROCHEMICAL HYDROGEN PUMP USING NEW PHOSPHONIC ACID TETHERED IONOMER BINDERS AND HT-PEM” filed on May 11, 2021, the disclosure of which is incorporated herein in by reference in its entirety.

In addition, this application claims the benefit of and priority to U.S. Provisional Application Ser. No. 63/192,607, having the title “ION-PAIR HT-PEMS FOR HYDROGEN SEPARATIONS USING ELECTROCHEMICAL PUMPING” filed on May 25, 2021, the disclosure of which is incorporated herein in by reference in its entirety.

### FEDERAL SPONSORSHIP

This invention was made with government support under Grant No. DE-EE0009101, awarded by U.S. Department of Energy. The government has certain rights in the invention.

### BACKGROUND

Ionomer binders can influence the performance and stability of electrochemical processes. In low- and high-temperature polymer electrolyte membrane (i. e., LT-PEM and HT-PEM) architectures involving hydrogen, the binders hold the electrocatalyst/electrocatalyst supports, while also delivering protons to and from the electrocatalyst to the PEM separator. PEM separators necessitate low gas permeability for safety and preventing contaminant crossover, while ionomer binders require high gas permeability for energy efficiency.

### SUMMARY

The present disclosure provides for electrochemical hydrogen pumps and methods of producing and/or purifying hydrogen. The present disclosure provides an electrochemical hydrogen pump, comprising: a first electrode coating disposed on a second side of a first substrate or on a first side of a high temperature polymer electrolyte membrane, wherein the second side of the first substrate opposes the first side of the high temperature polymer electrolyte membrane; and a second electrode coating disposed on a second side of the high temperature polymer electrolyte membrane or on the second side of a second substrate, wherein the second side of the high temperature polymer electrolyte membrane opposes the second side of the second substrate, wherein the first substrate has the characteristic of a porous gas diffusion layer that is conductive and serves as an anode and the second substrate has the characteristic of a porous gas diffusion layer that is conductive and serves as a cathode, wherein the first electrode coating comprises a phosphonic acid ionomer without liquid (e.g., a first phosphonic acid ionomer without liquid) and a plurality of catalyst particles (e.g., first catalyst particles), wherein the second electrode coating comprises a phosphonic acid ionomer without liquid (e.g., a second phosphonic acid ionomer without liquid) and a plurality of catalyst particles (e.g., second catalyst particles). The first phosphonic acid ionomer without liquid and the second phosphonic acid ionomer without liquid can be the same or different. The first catalyst particles and the second catalyst particles can be the same or different.

The present disclosure provides methods of producing, purifying, and/or compressing hydrogen gas, comprising: introducing a gas mixture to the anode of the electrochemical hydrogen pump as described above and herein, and generating hydrogen gas.

### BRIEF DESCRIPTION OF THE DRAWINGS

Further aspects of the present disclosure will be more readily appreciated upon review of the detailed description of its various embodiments, described below, when taken in conjunction with the accompanying drawings.

FIG. 1.1 illustrates the chemical structures of the HT-ionomer thin films and electrode binders characterized and used in this work.

FIG. 1.2A illustrates single-cell electrochemical hydrogen pump (EHP) iR-corrected polarization behavior with the same HT-PEM and Pt/C loadings (0.5 mg_{Pt} cm⁻²) but with different types of electrode binders. FIG. 1.2B illustrates Nyquist plots from EHP experiments with the MEAs featuring different electrode binders as a function of temperature.

FIG. 1.3A illustrates single-cell EHP iR-corrected polarization behavior using PTFSPA as the electrode binder and 1 mg_{Pt} cm⁻² for each electrode. The MEA used the QPPSf-PBI H₃PO₄ HT-PEM FIG. 1.3B illustrate the performance comparison against the current state-of-the art existing various single-cell HT-PEM EHPs^{6,30} with PTFSPA electrode binder

FIG. 1.4 illustrates non-iR corrected polarization curves for the EHP at 160° C. to 220° C.

FIG. 2.1A illustrates HT-PEM EHP experimental setup that can purify hydrogen from several types of hydrogen mixtures containing CO, CO₂, CH₄, and/or N₂. FIG. 2.1B illustrates the chemical structures of the ion-pair HT-PEM and electrode ionomer binder (PTFSPA—a random copolymer).

FIG. 2.2A-2.2C illustrates EHP polarization curves for the different gas mixtures and pure H₂ at (FIG. 2.2A) 200° ° C. and (FIG. 2.2B) 220° C. The traces in (FIG. 2.2A) demonstrates that the polarization is governed by H₂ concentration in the anode as syngas and reformate 2 contain 25% to 30% H₂ and WGS effluent and reformate 1 contain 75 to 76% H₂. At 200° C., a slightly lower temperature, polarization behavior is also a function of H₂ content in the gas feed but gas streams for almost the same H₂ content show greater polarization if they contain more CO. FIG. 2.2C illustrates cell voltage at 0.5 A cm⁻² versus CO content in the H₂ gas mixture. The gas mixture with 40% CO is syngas. The gas mixture with 25% CO is reformate 1. The gas mixture with 3% CO is reformate 2. The gas mixture with 20 ppm is WGS effluent. At 220° ° C., the cell polarization behavior is only affected by 90 mV or less when varying the CO content from 40% to 0%. Conversely, there is over a 1 V difference between 40% and 0% CO concentrations at 160° C.

FIG. 2.3A illustrates the HT-PEM EHP stability test at 200° C. and a constant current of 0.25 A cm⁻² with a syngas feed to the anode. FIG. 2.3B illustrates the HT-PEM EHP polarization at 200° ° C. with syngas before and after the 100 hour stability test.

FIG. 2.4A-2.4E illustrates the steady-state polarization curves as function of temperature (160° C. to 220° C.) for HT-PEM EHP for the following gas fed to the anode: (FIG. 2.4A) pure hydrogen, (FIG. 2.4B) syngas, (FIG. 2.4C) reformate 1, (FIG. 2.4D) syngas, or (FIG. 2.4E) reformate 2.

FIG. 2.5 illustrates hydrogen purity (HP) versus hydrogen recovery rate (HRR) for HT-PEM EHP, normal temperature pressure swing adsorption (PSA) (NT-PSA), elevated temperature PSA (ET-PSA), and sorption enhanced water gas shift (SEWGS) technologies. At 200° C., the ion-pair HT-PEM EHP in this work purified hydrogen from a WGS reactor effluent to 99.8% while having a 98.8% HRR. For a syngas feed to the ion-pair HT-PEM EHP, the HRR was 93.8% and the HP was 99.3%. Literature data from⁸⁻¹⁷.

FIGS. 2.6A and 2.6B illustrates the HT-PEM EHP performance comparison for ion-pair HT-PEM (this work) and PBI separator. Polarization curves with (FIG. 2.6A) Reformate 2 (data from⁸), and (FIG. 2.6B) WGS effluent (data from⁹) fed to the anode.

FIG. 2.7A illustrates the steady-state polarization curves as function of temperature (160° ° C. to 220° C.) for PBI HT-PEM and PTFSPA ionomer binder EHP for syngas while FIG. 2.7B illustrates the HT-PEM EHP stability test comparison for ion-pair HT-PEM (this work) and PBI at 200° C. and a constant current of 0.25 A cm⁻² with a syngas feed to the anode.

### DETAILED DESCRIPTION

Before the present disclosure is described in greater detail, it is to be understood that this disclosure is not limited to particular embodiments described, as such may, of course, vary. It is also to be understood that the terminology used herein is for the purpose of describing particular embodiments only, and is not intended to be limiting, since the scope of the present disclosure will be limited only by the appended claims.

Where a range of values is provided, it is understood that each intervening value, to the tenth of the unit of the lower limit (unless the context clearly dictates otherwise), between the upper and lower limit of that range, and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

Embodiments of the present disclosure will employ, unless otherwise indicated, techniques of chemistry, inorganic chemistry, synthetic chemistry, and the like, which are within the skill of the art. Such techniques are explained fully in the literature.

The following description and examples are put forth so as to provide those of ordinary skill in the art with a complete disclosure and description of how to perform the methods and use the compositions and compounds disclosed and claimed herein. Efforts have been made to ensure accuracy with respect to numbers (e.g., amounts, temperature, etc.), but some errors and deviations should be accounted for. Unless indicated otherwise, parts are parts by weight, temperature is in ° C., and pressure is in bar or psig. Standard temperature and pressure are defined as 25° C. and 1 bar.

Before the embodiments of the present disclosure are described in detail, it is to be understood that, unless otherwise indicated, the present disclosure is not limited to particular materials, reagents, reaction materials, manufacturing processes, or the like, as such can vary. It is also to be understood that the terminology used herein is for purposes of describing particular embodiments only, and is not intended to be limiting. It is also possible in the present disclosure that steps can be executed in different sequence where this is logically possible. Different stereochemistry is also possible, such as products of cis or trans orientation around a carbon-carbon double bond or syn or anti addition could be both possible even if only one is drawn in an embodiment.

It must be noted that, as used in the specification and the appended claims, the singular forms “a,” “an,” and “the” include plural referents unless the context clearly dictates otherwise. Thus, for example, reference to “a support” includes a plurality of supports. In this specification and in the claims that follow, reference will be made to a number of terms that shall be defined to have the following meanings unless a contrary intention is apparent.

### General Discussion

Conventional hydrogen separations from reformed hydrocarbon often deploy a water gas shift (WGS) reactor to convert CO to CO₂ followed by adsorption processes to achieve pure hydrogen. The purified hydrogen is then fed to a compressor to deliver hydrogen at high pressures. However, conventional hydrogen separation techniques are complicated. EHPs featuring proton selective polymer electrolyte membranes (PEMs) represent an alternative separation platform with fewer unit operations because they can simultaneously separate and compress hydrogen continuously.

The present disclosure provides for electrochemical hydrogen pumps and methods of producing, purifying, and/or compressing hydrogen. Embodiments of the present disclosure provide for efficient and high yielding electrochemical hydrogen pumps that can operate at high temperatures (e.g., about 200° C.) where other pumps cannot operate effectively. Gas mixtures, especially those that contain carbon monoxide (CO), which causes problems for other electrochemical hydrogen pumps (EHP) s that purify and/or compress hydrogen with embodiments of the present disclosure.

In a particular aspect, a high-temperature polymer electrolyte membrane (HT-PEM) EHP can purify hydrogen to 99.3% with greater than 85% hydrogen recovery for feed mixtures containing 25%-40% CO. The ion-pair HT-PEM and phosphonic acid ionomer binder enabled EHP operation in the temperature range 160 to 220° C. The ability to operate the EHP at an elevated temperature allowed the EHP to purify hydrogen from gas feeds with large CO contents and at 1 A cm⁻². In addition, the EHP only displayed a small performance loss of 12 μV h-1 for 100 hours at 200° ° C. for purifying hydrogen from syngas. Additionally, detail regarding these aspects are provided for in Examples 1 and 2.

In an aspect, the EHP of the present disclosure incudes a first substrate including a first electrode coating. The EHP can also include a second substrate that includes a second electrode coating. A high temperature polymer electrolyte membrane (HT-PEM) is positioned between the first substrate and the second substrate. The first electrode coating and the second electrode coating includes a phosphonic acid ionomer free of any liquids and a plurality of catalyst particles. The first substrate is an anode and the second substrate is a cathode. A gas mixture is presented to the anode and purified hydrogen or purified and compressed hydrogen can be produced at the cathode.

In another aspect, the EHP incudes a first substrate and a second substrate. A high temperature polymer electrolyte membrane is positioned between the first substrate and the second substrate, where for the sides adjacent the first substrate and the second substrate the high temperature polymer electrolyte membrane includes a first electrode coating and a second electrode coating, respectively. The first electrode coating and the second electrode coating include a phosphonic acid ionomer without liquid and a plurality of catalyst particles. The first substrate is an anode and the second substrate is a cathode. A gas mixture is presented to the anode and hydrogen is produced at the cathode.

Now having described the present disclosure generally, additional details are provided. The EHP can be used to produce hydrogen, purifying hydrogen, and/or compress at the cathode by presenting a gas mixture at the anode of the electrochemical hydrogen pump. The gas mixture can be selected from various reformed hydrocarbons that have large CO concentrations, small CO concentrations, or no CO; here is a list of some model examples: i.) syngas composed of 25% hydrogen, 40% carbon monoxide, 15% carbon dioxide, 15% methane, and 5% nitrogen; ii.) hydrocarbon reformate −30% hydrogen, 3% carbon monoxide, and 67% nitrogen; iii.) water gas shift reaction effluent with 75% hydrogen, 20% carbon dioxide, 5% methane, and 20 ppm carbon monoxide; iv.) and another hydrocarbon reformate mixture with 75% hydrogen and 25% carbon monoxide, or a combination thereof. In another application, the hydrogen pump can be used to purify hydrogen from gas stored in the natural gas pipeline. The gas mixture in the natural gas pipeline with hydrogen may contain 1 to 20% hydrogen and the remainder balanced with natural gas. The EHP can purify the hydrogen out of the natural gas pipeline to about +99% for use as a fuel or other downstream chemical processes.

The EHP can produce 99.3% to 100% pure hydrogen at the cathode from a gas mixture fed to the anode. The EHP is stable (e.g., voltage increase less than 15 μV/hr) at about 200° C. for over 100 hours. The EHP can operate at about 80 to 300° C., 160 to 300° C. or −20 to 250° ° C. and in particular at 200° ° C. with over 100 hours stability.

The thickness (width) of the anode, the high temperature polymer electrolyte membrane, and the cathode can be about 75 to 275 microns or about 75 to 125 microns. The high-temperature polymer electrolyte membrane thickness can vary from 2 μm to 200 microns with a nominal thickness that is often about 50 microns. The first substrate can have a thickness of about 500 nm to 50 microns but often has a nominal thickness of 2 microns to 30 microns. The second substrate can have a thickness of about 500 nm to 50 microns but often has a nominal thickness of 2 microns to 30 microns.

In an aspect, the EHP can include the first electrode coating disposed on a second side of a first substrate (e.g., anode) and/or on a first side of a high temperature polymer electrolyte membrane. The second side of the first substrate opposes and is adjacent to the first side of the high temperature polymer electrolyte membrane. The EHP also includes the second electrode coating disposed on a second side of the high temperature polymer electrolyte membrane and/or on the second side of a second substrate (e.g., cathode). The second side of the high temperature polymer electrolyte membrane opposes and adjacent the second side of the second substrate.

The first substrate (e.g., a carbon paper or other materials that have similar properties) is a porous gas diffusion layer that is conductive and serves as an anode. Similarly, the second substrate (e.g., a carbon paper or other materials that have similar properties) is a porous gas diffusion layer that is conductive and serves as a cathode.

The first electrode coating and the second electrode coating, independently, comprise a phosphonic acid ionomer that contains no liquid and a plurality of catalyst particles. In an aspect, the catalyst particles can be carbon particles having metal (e.g., platinum, palladium, iridium, gold, silver, and other transition metals) particles disposed thereon. The carbon particles have a diameter of about 50 nm to 2 μm, and the metal particles have a diameter of about 2 nm to 20 nm. In as aspect, the phosphonic acid ionomer that contains no liquid in the first electrode coating and the phosphonic acid ionomer that contains no liquid in the second electrode coating can be the same or different. Similarly, the plurality of catalyst particles in the first electrode coating and the plurality of catalyst particles in the second electrode coating can be the same or different.

The phosphonic acid ionomer that contains no liquid can have the characteristic of a binder for the plurality of catalyst particles in the first electrode coating and the second electrode coating. The phosphonic acid ionomer that contains no liquid can have a proton conductivity of greater than about 0.001 to 0.05 S cm⁻¹ at 200 to 220° ° C. The phosphonic acid ionomer that contains no liquid can have a gas permeability to H₂ gas permeability that is about 5× or greater than a gas permeability to H₂ for a phosphoric acid (H₃PO₄) imbibed quaternary benzyl pyridinium polysulfone (QPPSf) thin film polymer electrolyte.

The phosphonic acid ionomer that contains no liquid can be a phosphonic acid functionalized polypentafluorostyrene. The phosphonic acid ionomer that contains no liquid can be poly(tetraflurostyrene phosphonic acid-co-pentafluorostyrene) (PTFSPA).

The high-temperature polymer electrolyte membrane can be based upon phosphoric acid imbibed polycations or phosphoric acid imbibed polycations blended with polybenzimidazole and operates and conducts ions at temperature of −20 to 300° C. The electrodes in these assemblies used the ionomers of the present disclosure as electrode binders. Using PTFSPA as the binder, an HT-PEM EHP showed 1 A cm⁻² at 55 mV when using 2 mg_{Pt} cm⁻² in the membrane electrode assembly. Additional details are provided in the Examples.

### EXAMPLES

Now having described the embodiments of the disclosure, in general, the examples describe some additional embodiments. While embodiments of the present disclosure are described in connection with the example and the corresponding text and figures, there is no intent to limit embodiments of the disclosure to these descriptions. On the contrary, the intent is to cover all alternatives, modifications, and equivalents included within the spirit and scope of embodiments of the present disclosure.

### Example 1

Ionomer binders strongly influence the performance and stability of numerous electrochemical processes such as fuel cells¹⁻⁴, water⁵ and carbon dioxide electrolyzers⁶, and deionization units^{7, 8}. In low- and high-temperature polymer electrolyte membrane (i.e., LT-PEM and HT-PEM) architectures involving hydrogen, the binders hold the electrocatalyst/electrocatalyst supports, while also delivering protons to and from the electrocatalyst to the PEM separator. Both PEM separators and ionomer electrode binders require high conductivity and stability^{4, 9} under a wide-range of conditions (e.g., chemical, electrochemical, and thermal), but there are nuanced differences with respect to the properties for PEM separators and electrode binders. PEM separators necessitate low gas permeability, especially contaminants like CO. Ionomer binders require high gas permeability to overcome mass transfer related resistances and enable high current density^{10, 11}.

In the electrode layers, the ionomer binder often serves as a thin adhesive coating on the electrocatalyst/electrocatalyst support particles¹². A few research groups have shown that Nafion® can display substantially different proton conductivity and water uptake properties when confined as a thin film (5 to 100 nm) when compared to its properties as a bulk membrane¹³⁻¹⁹. It is worth noting that there is a lack of studies investigating how the properties of other thin film ionomers influence electrochemical properties, such as charge-transfer reaction kinetics as well as gas permeability, in addition to other types of ionomer chemistries for hydrogen-based electrochemical systems. These other properties have a more profound impact on electrochemical device performance when compared to ionic conductivity²⁰. For example, ionomers can alter redox reaction rates (e.g., by adsorption of the tethered ion to the catalyst)^{21, 22} and gas reactant mass transfer rates to the electrocatalyst surface^{11, 20, 23, 24}.

Electrochemical hydrogen pumps (EHPs) are used for hydrogen separations and compression in industrial settings³⁰⁻³⁶, in addition to being a diagnostic tool for fuel cells. Combining the ion-pair HT-PEM separator with Pt/C electrodes using the PTFSPA binder, we have demonstrated that an EHP that can operate at 1 A cm⁻² at 120 mV using 1 mg_{Pt} cm⁻² in the membrane electrode assembly (MEA) and at 55 mV at 220° C. using 2 mg_{Pt} cm⁻² in the MEA. These values represent the best performance in the peer-reviewed literature for a HT-PEM EHP. However, it should be noted that LT-PEMs (e.g., perfluorosulfonic acid materials like Nafion®), using humidification, can achieve the same current density values at lower voltage (0.04 to 0.09 V)^{34, 35} at lower platinum loadings (<1 mg_{Pt} cm⁻² for the MEA). Although LT-PEM EHPs have better performance, they require substantial gas humidification and suffer more in performance loss with greater concentration of contaminants in the hydrogen mixture (e.g., carbon monoxide (CO)). Raising the temperature above 180° C. makes the EHP more resilient to contaminants enabling more effective hydrogen separations. Also, the environment for HT-PEM EHP is not as harsh as HT-PEMFC and LT-PEM EHP as the cell has no oxygen and water.

### Results and Discussions

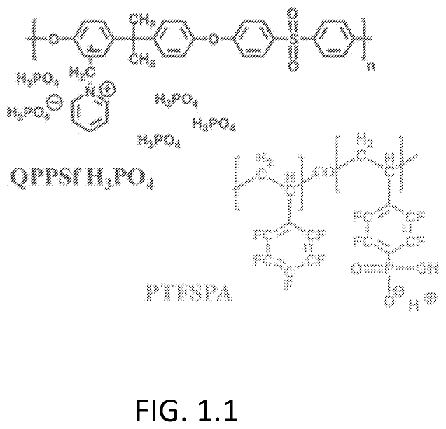

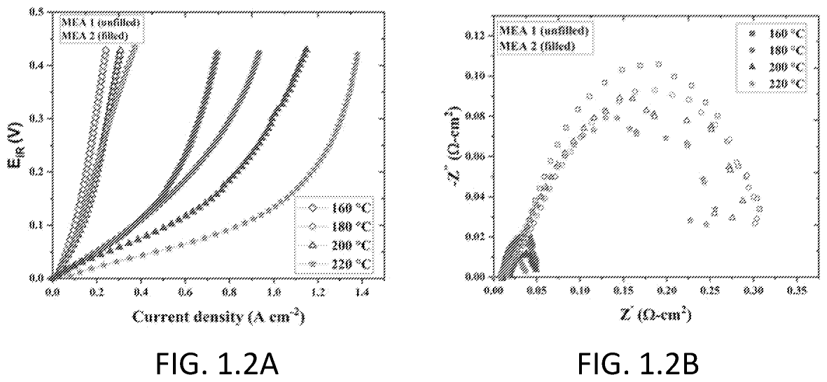

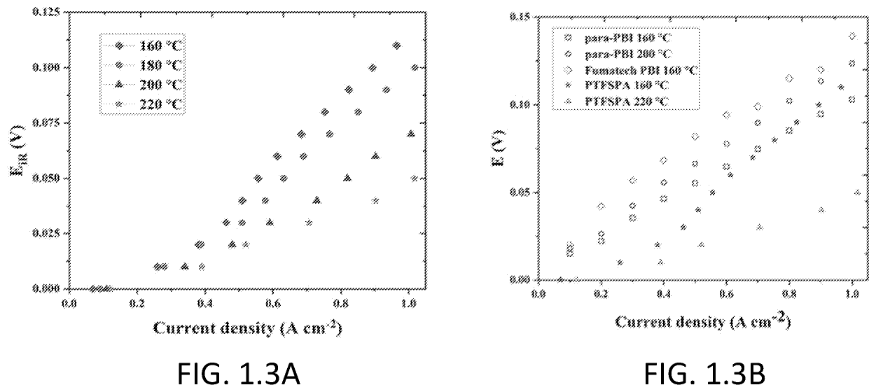

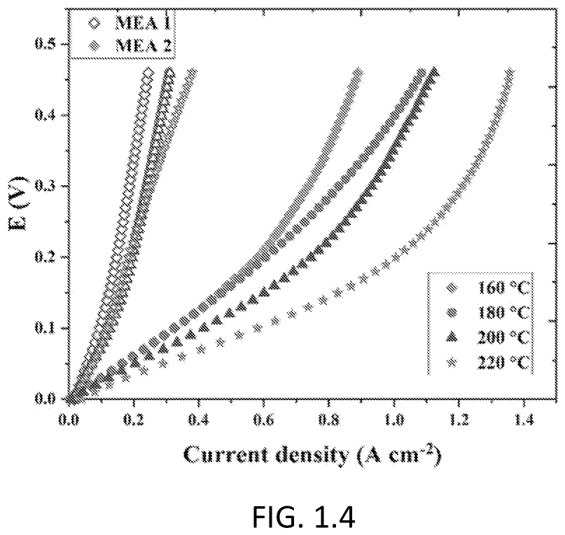

The chemical structures of the HT-ionomers (PTFSPA and quaternary benzyl pyridinium poly(arylene ether sulfone) imbibed with H₃PO₄ (QPPSf H₃PO₄)) are shown in FIG. 1.1. PTFSPA was synthesized following the procedure of Atanasov et al.⁴¹ QPPSf H₃PO₄ was prepared as described in our previous work²⁶. PTFSPA thin films after activation with 5 wt. % H₃PO₄ for 10 minutes, has the same ionic conductivity as QPPSf H₃PO₄ up to 125° C., and its conductivity value is within 5 to 10 mS cm⁻¹ of QPPSf H₃PO₄ in the temperature range of 150 to 225° C. The ionic conductivity of PTFSPA thin film without exposure to H₃PO₄ for activation is very low compared to QPPSf H₃PO₄ and PTFSPA exposed to H₃PO₄. The ionic conductivity of the PTFSPA thin film without exposure to H₃PO₄ rapidly increased from 10⁻² to 2 mS cm⁻¹ as the temperature increased from 100° C. to 220° C.

The ability of PTFSPA to provide adequate ionic conductivity without the need for water and an imbibed acid across a wide temperature range makes it a good candidate for HT-PEM fuel cells and EHPs. It was anticipated that the removal of liquid H₃PO₄ would enhance mass transfer in the electrodes in the devices as well as improve redox kinetics. H₃PO₄ is known to have a detrimental effect on oxygen reduction reaction (ORR) kinetics in HT-PEM fuel cell cathodes because of phosphate anion adsorption on the platinum catalyst surface⁴².

Membrane electrode assemblies (MEAs) were fabricated for single-cell EHP studies. The MEAs consisted of QPPSf PBI H₃PO₄ HT-PEM separators and Pt/C gas diffusion electrodes (GDEs) that used QPPSf H₃PO (termed MEA 1) and PTFSPA (termed MEA 2) as electrode binders. The iR-corrected single-cell EHP polarization curves for the MEAs that feature the different electrode binders at different temperatures (160 to 220° C.) are presented in FIG. 1.3A, and the non-iR corrected polarization curves are provided in FIG. 1.12. There are two salient features in FIG. 1.3A: i.) the MEA with a PTFSPA electrode binder outperformed the MEA with a QPPSf H₃PO₄ electrode binder and ii.) as the cell temperature increased, the polarization decreased more with PTFSPA as the electrode binder, while the polarization remained about the same with QPPSf H₃PO₄ as the electrode binder.

The Nyquist plots from electrochemical impedance spectra taken at no applied potential during EHP experiments are given in FIG. 1.3B. The charge-transfer resistance was 0.04 Ω-cm² or less with PTFSPA as the electrode binder, while the charge-transfer resistance for QPPSf H₃PO₄ was >0.25 Ω-cm² (i.e., at least 6× greater). In the next set of analyses, the linear-regime and limiting current density values of the polarization curves were analyzed for extracting i_{@η-150 mv} and P_{H}_{₂} values for single-cell EHPs. The P_{H}_{₂} and i_{@η-150 mV} values as a function of temperature The P_{H}_{₂} and i_{@η-150 mV} values were greater for the MEAs containing PTFSPA as the binder over QPPSf H₃PO₄ as the electrode binder (e.g., 6× for P_{H}_{₂} and 4-6× greater for i_{@η-150 mV}).

The lower charge-transfer resistance from FIG. 1.3B and greater i_{@η-150 mV} for PTFSPA electrode binder might be due to lower phosphate anion adsorption on the platinum electrocatalyst. Phosphate and phosphonate anions hinder electrocatalyst utilization in both anode and cathode⁴². Because QPPSf-H₃PO₄ has more phosphate groups per weight, more anion adsorption takes place accounting for the larger charge-transfer resistance and low i_{@η-150 mV} when compared to PTFSPA. The binder PTFSPA has fewer phosphonate anions, and these anions are tethered to the backbone and its degrees of freedom with respect to translational motion is restricted when compared to H₃PO₄. Hence, these reasons account for the better current response observed for a given voltage in IDEs and single-cell MEA EHP when using PTFSPA as the thin film electrolyte and electrode binder, respectively.

Our initial studies using PTFSPA electrode binders were carried out with 1 mg_{Pt} cm⁻² in the MEA. To compare against the current state-of-the-art existing data on HT-PEM EHPs in the literature, another MEA was fabricated with 2 mg_{Pt} cm⁻² in the MEA (equal loading on each electrode) with PTFSPA binder. The EHP polarization curve of this MEA is given in FIG. 1.4A and the performance is compared against state-of-the art data in FIG. 1.4B^{6,30}. The HT-PEM EHP with PTFSPA electrode binder displayed a very low voltage requirement (see Table 1) and best performance compared to the current HT-PEM EHPs^{6,30}.

A notable difference between HT-PEM and LT-PEM EHP studies in the literature is the platinum loading in the electrodes. LT-PEM EHPs use about 0.5 mg_{Pt} cm⁻² to 0.8 mg_{Pt} cm⁻² in the MEA, while HT-PEMs typically use 2 mg_{Pt} cm⁻². Although LT-PEM EHPs have better performance with lower platinum loading, high temperature operation of HT-PEM EHPs assists in overcoming catalyst poisoning and deactivation due to contaminants in the hydrogen mixture (e.g., carbon monoxide (CO))^{1,6,26,30}. Hence, operating the EHP at higher temperatures allows for more effective hydrogen separations and purification from mixtures with larger fractions of contaminants and smaller concentrations of hydrogen (i.e., a dirtier mixture).

TABLE 1
Performance comparison of various single-cell HT-
PEM EHPs with the same Pt loading in electrodes.

| | | Anode/cathode | | | |
|---|---|---|---|---|---|
| | Electrode binder & | catalyst loading | Temperature | Cell voltage | |
| Membrane | electrocatalyst used | (mg_{Pt} cm⁻²) | (° C.)/RH (%) | (V) at 1 A cm⁻² | Reference |
| Fumatech PBI | PBI with Pt/C | — | 160° C./0% | 0.14 | 30 |
| Para-PBI | BASF electrodes that | 1.0/1.0 | 160° C./1.6% | 0.10 | 6 |
| | contain Pt* | | | | |
| Para-PBI | BASF electrodes that | 1.0/1.0 | 200° C./1.6% | 0.12 | 6 |
| | contain Pt* | | | | |
| 50:50 QPPSf | PTFSPA | 1.0/1.0 | 160° C./0% | 0.11 | This work |
| PBI H₃PO₄ | | | | | |
| 50:50 QPPSf | PTFSPA | 1.0/1.0 | 200° C./0% | 0.075 | This work |
| PBI H₃PO₄ | | | | | |
| 50:50 QPPSf | PTFSPA | 1.0/1.0 | 220° C./0% | 0.055 | This work |
| PBI H₃PO₄ | | | | | |

*Exact composition of this electrode is unknown

### CONCLUSIONS

In summary, we show here that PTFSPA is a more effective electrode binder for EHPs over QPPSf-H₃PO₄ binders because it does not contain liquid acid known to obfuscate hydrogen gas permeability and hinder reaction kinetics due to phosphate anion adsorption on the electrocatalyst surface. Implementing PTFSPA materials as electrode binders in HT-PEM EHPs results in excellent performance of 1 A cm⁻² at 55 mV.

### REFERENCES FOR EXAMPLE 1

1. V. Atanasov, A. S. Lee, E. J. Park, S. Maurya, E. D. Baca, C. Fujimoto, M. Hibbs, I. Matanovic, J. Kerres and Y. S. Kim, Nature Materials, 2021, 370-377.
2. W. E. Mustain, Current Opinion in Electrochemistry, 2018, 12, 233-239.
3. Y. S. Kim, ACS Applied Polymer Materials, 2021, 1250-1270.
4. A. Kobayashi, T. Fujii, C. Harada, E. Yasumoto, K. Takeda, K. Kakinuma and M. Uchida, ACS Applied Energy Materials, 2021.

5. D. Li, E. J. Park, W. Zhu, Q. Shi, Y. Zhou, H. Tian, Y. Lin, A. Serov, B. Zulevi, E. D. Baca, C. Fujimoto, H. T. Chung and Y. S. Kim, Nature Energy, 2020, 5, 378-385.
6. R. B. Kutz, Q. Chen, H. Yang, S. D. Sajjad, Z. Liu and I. R. Masel, Energy Technology, 2017, 5, 929-936.
7. V. M. Palakkal, L. Valentino, Q. Lei, S. Kole, Y. J. Lin and C. G. Arges, npj Clean Water 2020, 3, 5.
8. A. P. Bhat, E. R. Reale, M. del Cerro, K. C. Smith and R. D. Cusick, Water Resesearch X, 2019, 3, 100027.
9. B. Choi, D. A. Langlois, N. Mack, C. M. Johnston and Y. S. Kim, Journal of the Electrochemical Society, 2014, 161, F1154-F1162, 1159 pp.
10. A. Kongkanand and M. F. Mathias, Journal of Physical Chemistry Letters, 2016, 7, 1127-1137.
11. A. Katzenberg, A. Chowdhury, M. Fang, A. Z. Weber, Y. Okamoto, A. Kusoglu and M. A. Modestino, Journal of the American Chemical Society, 2020, 142, 3742-3752.
12. K. More, R. Borup and K. Reeves, ECS Transactions, 2019, 3, 717-733, 12.
13. M. A. Modestino, D. K. Paul, S. Dishari, S. A. Petrina, F. I. Allen, M. A. Hickner, K. Karan, R. A. Segalman and A. Z. Weber, Macromolecules, 2013, 46, 867-873.
14. A. Kusoglu, D. Kushner, D. K. Paul, K. Karan, M. A. Hickner and A. Z. Weber, Advanced Functional Materials, 2014, 24, 4763-4774.
15. D. K. Paul, R. McCreery and K. Karan, Journal of the Electrochemical Society, 2014, 161, F1395-F1402.
16. S. K. Dishari and M. A. Hickner, ACS Macro Letters, 2012, 1, 291-295.
17. S. K. Dishari and M. A. Hickner, Macromolecules, 2013, 46, 413-421.
18 S. K. Dishari, C. A. Rumble, M. Maroncelli, J. A. Dura and M. A. Hickner, Journal of Physical Chemistry C, 2018, 122, 3471-3481.
19. S. Farzin, A. Sarella, M. A. Yandrasits and S. K. Dishari, The Journal of Physical Chemistry C, 2019, 123, 30871-30884.
20. A. Y. Abdulla, Undergraduate Thesis, Princeton University, 2009.
21. I. Matanovic, S. Maurya, E. J. Park, J. Y. Jeon, C. Bae and Y. S. Kim, Chemistry of Materials, 2019, 31, 4195-4204.
22. R. Subbaraman, D. Strmcnik, V. Stamenkovic and N. M. Markovic, Journal of Physical Chemistry C, 2010, 114, 8414-8422.
23. S. Sambandam and V. Ramani, Physical Chemistry Chemical Physics, 2010, 12, 6140-6149.
24. S. Sambandam, J. Parrondo and V. Ramani, Physical Chemistry Chemical Physics, 2013, 15, 14994-15002.
25. A. Chaichi, G. Venugopalan, R. Devireddy, C. Arges and M. R. Gartia, ACS Appl. Energy Mater., 2020, 3, 5693-5704.
26. G. Venugopalan, K. Chang, J. Nijoka, S. Livingston, G. M. Geise and C. G. Arges, ACS Appl. Energy Mater., 2020, 3, 573-585.
27. K.-S. Lee, J. S. Spendelow, Y.-K. Choe, C. Fujimoto and Y. S. Kim, Nature Energy, 2016, 1, 16120.
28. K.-S. Lee, S. Maurya, Y. S. Kim, C. R. Kreller, M. S. Wilson, D. Larsen, S. E. Elangovan and R. Mukundan, Energy & Environmental Science, 2018, 11, 979-987.
29. A. S. Lee, Y.-K. Choe, I. Matanovic and Y. S. Kim, Journal of Materials Chemistry A, 2019, 7, 9867-9876.
30. K. A. Perry, G. A. Eisman and B. C. Benicewicz, Journal of Power Sources, 2008, 177, 478-484.
31. K. Fishel, G. Qian, G. Eisman and B. C. Benicewicz, in High Temperature Polymer Electrolyte Membrane Fuel Cells, ed. Q. Li, Springer International Publishing, Switzerland, 2016, pp. 527-540.
32. F. Huang, A. T. Pingitore and B. C. Benicewicz, ACS Sustainable Chemistry & Engineering, 2020, 8, 6234-6242.
33. F. Huang, A. T. Pingitore and B. C. Benicewicz, Journal of the Electrochemical Society, 2020, 167, 63504.
34. C. Jackson, L. F. J. M. Raymakers, M. J. J. Mulder and A. R. J. Kucernak, Applied Catalysis, B: Environmental, 2020, 268, 118734.
35. C. Jackson, L. F. J. M. Raymakers, M. J. J. Mulder and A. R. J. Kucernak, Journal of Power Sources, 2020, 472, 228476.
36. A. Y. Abdulla, Undergraduate Thesis, Princeton University, 2009.
37. R. P. Singh, X. Li, K. W. Dudeck, B. C. Benicewicz and K. A. Berchtold, Polymer, 2017, 119, 134-141.
38. A. T. Pingitore, F. Huang, G. Qian and B. C. Benicewicz, ACS Applied Energy Materials, 2019, 2, 1720-1726.
39. D. Chen, A. Kongkanand and J. Jorne, Journal of the Electrochemical Society, 2019, 166, F24-F33.
40. D. Bhattacharya, S. Kole, O. Kizilkaya, J. Strzalka, P. P. Angelopoulou, G. Sakellariou, D. Cao and C. G. Arges, Small. (accepted, doi: 10.1002/smll.202100437)
41. V. Atanasov, A. Oleynikov, J. Xia, S. Lyonnard and J. Kerres, Journal of Power Sources, 2017, 343, 364-372.
42. Y. Hu, Y. Jiang, J. O. Jensen, L. N. Cleemann and Q. Li, Journal of Power Sources, 2018, 375, 77-81.

### Example 1 Supplemental Information

### Synthesis of QPPSf (Quaternary Benzyl Pyridinium Poly (Arylene Ether Sulfone))

QPPSf was synthesized by converting the chloromethylated groups in chloromethylated poly (arylene ether sulfone) (CMPSf) to quarterly benzyl pyridinium groups. CMPSf was synthesized by Friedel-Crafts reaction.6 FIG. 1.7A depicts the synthesis scheme. 20 g of Udel® poly (arylene ether) sulfone (PSf) was dissolved in 1000 mL of chloroform in a round bottom flask at 40° ° C. Once the PSf was completely dissolved, 13.6 g of paraformaldehyde and 60 mL of chlorotrimethylsilane was added. The reaction temperature was further increased to 55° C., the flask was sealed with a rubber septum and filled with nitrogen. To the sealed flask, 1050 μL of SnCl₄ was added. The reaction was monitored by withdrawing a sample from the flask, to control the degree of functionalization (DF), i.e., the addition of chloromethylated groups per repeat unit. The sample was precipitated in methanol (5:1 methanol to sample ratio). The precipitate obtained was dried and analyzed via 1H NMR to calculate the DF. Once the desire DF was obtained, the reaction solution in the flask was precipitated in methanol (5:1 volume ratio). The precipitate was filtered and dried. To convert the CMPSf to QPPSf, CMPSf was dissolved in NMP (5 wt. %). To the CMPSf solution, pyridine was added (3:1 mole ratio) and reacted overnight, to convert the chloromethylated groups to quaternary benzyl pyridinium chloride groups. The resulting QPPSf solution (5 wt. %) were used for ionomer solution.

### Synthesis of PTFSPA (Poly(Tetraflurostyrene Phosphonic Acid-Co-Pentafluorostyrene))

The addition of phosphonic acid to poly(pentafluorostyrene) was carried out following the procedure by Atanasov et al.⁷ (FIG. 1.3B). 1 g PPFS (5.2 mmol) was dissolved in DMAc (4 g) at room temperature in a round bottom flask equipped with magnetic stirrer, reflux condenser and an oil bath. The temperature was increased to 170° C. and tris(trimethylsilyl) phosphite (TSP; 1.07 g, 3.6 mmol) was added dropwise, and the reaction was carried out for 16 hours. The resulting polymer solution was poured into DI water and the white solid was precipitated. The white solid polymer was refluxed in DI water for 30 minutes, by changing fresh water every 10 minutes, followed by boiling in 2 wt. % phosphoric acid solution and washing with DI water till a neutral pH was obtained. The PTFSPA white solid was dried in vacuum oven overnight. The phosphonic acid tethered groups were confirmed via ³¹P NMR. A 70% degree of phosphonation was assumed theoretically, controlled via TSP to PPFS ratio.^{8,9} The resulting PTFSPA was dissolved in DMSO to make an ionomer solution (5 wt. %).

### IEC of Samples

Ion-exchange capacity (IEC) of QPPSf was determined using 1H NMR. Theoretical IEC of QPPSf was calculated using equations 1 and 2⁶:

$$IEC ( \frac{mmol}{g} ) = \frac{DF \times 1000}{( {MW}_{PSf , monomer} + DF \times {MW}_{cation} )} \cdot Conversion \qquad ( 1 )$$

$${MW}_{cation} = ( {MW}_{cation free base conjugate} + {MW}_{counteranion} + {MW}_{{CH}_{2}} - 1 ) \qquad ( 2 )$$

The DF of CMPSf was calculated using the procedure from our previous work.¹⁰ The DF of CMPSf used in this work was 1.26. The percentage of conversion of chloromethylated groups to quaternary benzyl pyridinium groups was 91%. The IEC of QPPSf was using equation 1 was 1.7 mmol g⁻¹ (for the sample not containing H₃PO₄). For the sample containing acid, the number of H₃PO₄ per base (n H₃PO₄ B-1) was calculated using the procedure from our previous work.¹⁰ QPPSf-H₃PO₄ had n H₃PO₄B⁻¹ of 9.4.

IEC of PTFSPA was determined using a base titration. A sample of PTFSPA was immersed in 1 M sodium chloride (NaCl) for 24 hours for exchanging the protons for sodium ions. This solution was titrated against 0.1 M sodium hydroxide (NaOH) solution until equivalence point observed using potassium permanganate indicator. The IEC of PTFSPA was calculated using equation 3.

$$IEC ( \frac{mmol}{g} ) = \frac{{V}_{NaOH} \times {N}_{NaOH}}{{w}_{dry}} \qquad ( 3 )$$

w_{dry} is the weight of dry PTFSPA.
The IEC of PTFSPA was using the base titration method was 2.5 mmol g⁻¹.

### Thermal Stability Assessment

The thermal stability of PTFSPA and QPPSf-H₃PO₄ was determined using Pyris 1 TGA (TA instruments) instrument under nitrogen. The samples were initially heated to 100° C. and equilibrated at that temperature for 10 minutes. Then, the temperature was heated up to 700° C. at the rate of 10° C. min⁻¹. The change in weight of the sample was monitored during the heating from 100° C. to 700° C.

### Preparation of GDEs and MEA Fabrication

The catalyst inks for fabrication of gas diffusion electrodes (GDEs) were prepared by mixing 0.2 g of platinum electrocatalyst supported on high surface area graphitic carbon (37% Pt/C, Tanaka Kikinzoku International) with 1.715 g of ionomer solution diluted with approximated 5.5 g of isopropyl alcohol (IPA). The prepared inks were sonicated for 30 minutes for dispersing the particles in the ink. The gas diffusion layers (GDLs) were then painted with the prepared catalyst inks using an aerosolized spray gun (nitrogen gas) to make GDEs. The active area of the resultant GDE was 5 cm². The catalyst loading was measured gravimetrically by measuring the weight change before and after painting and drying. The catalyst loading was maintained at 0.5 mg_{Pt} cm⁻² (or 1 mg_{Pt} cm⁻²) for each GDE (one used as the anode and the other as the cathode). The weight fraction of the ionomer in the electrode layer was 30 wt. % but it can be as low as 10 wt. %. The QPPSf GDEs were then immersed in 85 wt % H₃PO₄ for 10 minutes to imbibe acid into the electrodes. The MEAs were prepared by sandwiching the prepared GDEs with 50:50 QPPSf-PBI H₃PO₄ HT-PEM in a Fuel Cell Technologies Hardware setup (5 cm² geometric area). The assembled cell was plumbed to an 850 E Scribner Associates, Inc. Fuel Cell test station for HT-EHP studies.

HT-EHP Studies with MEAs

EHP tests were conducted using 850 E Scribner Associates, Inc. Fuel Cell test station. Before testing, the cell was heated to 120° C. under nitrogen on both anode and cathode. The cell was heated further to 180° C. under pure hydrogen on the anode and no sweep gas at the cathode. The polarization curves were obtained for 160° C., 180° C., 200° C., and 220° C. by performing chronoamperometry with 0.05 V potential step by holding the voltage for 30 seconds at each step to reach steady-state current from 0 V-0.7 V.

### REFERENCES FOR EXAMPLE 1 SUPPLEMENTARY INFORMATION

1 Z. Su, S. Kole, L. C. Harden, V. M. Palakkal, C. Kim, G. Nair, C. G. Arges and J. N. Renner, ACS Materials Lett., 2019, 1, 467-475.
2 C. G. Arges, Y. Kambe, M. Dolejsi, G.-P. Wu, T. Segal-Pertz, J. Ren, C. Cao, G. S. W. Craig and P. F. Nealey, J. Mater. Chem. A, 2017, 5, 5619-5629.
3 D. Bhattacharya, S. Kole, O. Kizilkaya, J. Strzalka, G. Angelopoulou, D. Cao and C. G. Arges, Small. (just accepted—doi: 10.1002/smll.202100437)
4 Q. Lei, K. Li, D. Bhattacharya, J. Xiao, S. Kole, Q. Zhang, J. Strzalka, J. Lawrence, R. Kumar and C. G. Arges, Journal of Materials Chemistry A, 2020, 8, 15962-15975.
5 K. M. Diederichsen, R. R. Brow and M. P. Stoykovich, ACS nano, 2015, 9, 2465-2476.
6 C. G. Arges, J. Parrondo, G. Johnson, A. Nadhan and V. Ramani, Journal of Materials Chemistry, 2012, 22, 3733-3744.
7 V. Atanasov, A. Oleynikov, J. Xia, S. Lyonnard and J. Kerres, Journal of Power Sources, 2017, 343, 364-372.
8 V. Atanasov, A. S. Lee, E. J. Park, S. Maurya, E. D. Baca, C. Fujimoto, M. Hibbs, I. Matanovic, J. Kerres and Y. S. Kim, Nature Materials, 2021, 370-377.
9 V. Atanasov and J. Kerres, Macromolecules, 2011, 44, 6416-6423.
10 G. Venugopalan, K. Chang, J. Nijoka, S. Livingston, G. M. Geise and C. G. Arges, ACS Appl. Energy Mater., 2020, 3, 573-585.
11 C. G. Arges, K. Li, L. Zhang, Y. Kambe, G.-P. Wu, B. Lwoya, J. N. Albert, P. F. Nealey and R. Kumar, Molecular Systems Design & Engineering, 2019, 4, 365-378.
12 L. A. Briceno-Mena, G. Venugopalan, J. A. Romagnoli and C. G. Arges, Patterns, 2021, 2, 100187.

### Example 2

Natural gas prices over the past 15 years have experienced a precipitous drop due to innovations made in fracking technology and extraction of this resource from shale layers¹. The 32% reduction in CO₂ emissions from the electric power sector in the United States since 2005 is largely attributed to natural gas supplanting coal for burning in thermal electric plants as it is cheaper and a cleaner fuel². However, natural gas combustion still yields CO₂, a greenhouse gas (GHG), and a large contributor to climate disruption. Meeting the ambitious goals of 50% GHG emission reduction by 2030 as outlined by the Biden Administration³, or the 2016 Paris Agreement⁴ to limit global temperature rises below 2° C., requires continued adoption of renewable energy sources, like solar, nuclear and wind, in addition to proliferation of energy storage technologies, like batteries, and the implementation of blue, green, and pink hydrogen as an energy vector and chemical feedstock in the global economy. As renewables displace natural gas as an energy source, there is still significant value in harnessing natural gas for carbon and hydrogen for chemical manufacturing (e.g., surfactants and plastics) and the production of fuels⁵.

Over 90% of hydrogen used in the United States is derived from steam methane reforming (SMR)⁶. SMR process uses natural gas as a feedstock and generates syngas, a mixture that primarily consists of hydrogen and carbon monoxide (CO) and some carbon dioxide (CO₂). It is important to note that numerous chemical processes⁷ use hydrogen from SMR—e.g., ammonia production for fertilizers by Haber-Bosch, desulfurization in petrochemical processes, metals refinining, chemical hydrogenation, and semiconductor manufacturing. The hydrogen used in these processes often require separation from syngas.

Conventional hydrogen separations encompass several different methods⁸ such as cryogenic cooling⁹, thermal metal hydride adsorption¹⁰, pressure swing adsorption¹¹, and palladium membranes¹². Electrochemical hydrogen pumps (EHPs)¹³ featuring proton selective polymer electrolyte membranes (PEMs) represent an alternative separation platform that can simultaneosly separate and compress hydrogen continuosly. Adsorption processes do not operate continously because they saturate and require regeneration. Palladium membranes require temperatures over 350° ° C. for hydrogen separations and they cannot be used for compression.

EHPs were originally developed by General Electric¹⁴ with the emergence of perfluorosulfonic acid (PFSA) membranes, such as Nafion™, and have been used for hydrogen compression and reuse in various industrial settings¹³. PFSA membranes do not function over 100° C. because they need condensed water within the membrane to mediate proton conduction¹⁵. Platinum electrocatalysts are the choice of materials for the hydrogen oxidation reaction (HOR) and hydrogen evolution reaction (HER) in EHPs that operate under acidic conditions. Reformed natural gas and other fossil fuels, however, contain CO that strongly adsorbs to platinum at low temperature making low-temperature PEM EHPs ineffective for hydrogen separations for gas mixtures containing CO. Concentrations of CO at 100 ppm or less are known to incur significant overpotentials that hamper EHP performance^{16,34}.

High-temperature polymer electrolyte membranes (HT-PEMs) based upon on phosphoric acid (H₃PO₄) imbibed polybenzimidazole (PBI) enable EHP operation at elevated temperatures (e.g., 180)° ° C. for hydrogen separations containing CO^{17,18}. But, there have been limited demonstrations of EHPs using PBI-H₃PO₄ separators for hydrogen separations. To date, these HT-PEM EHP studies have only processed hydrogen up to 3% CO at 1.6% RH and 160° C. to 200° C. Operating the EHP at high-temperature (200° C. to 250° C.) offers significantly improved Pt catalyst tolerance to CO and other impurities in the inlet gas stream, eventuating in better utilization of Pt catalyst for carrying out the hydrogen separation. Commercial PBI from Fumatech is unstable at temperatures above 180° C. for extended periods of time because H₃PO₄ evaporates from PBI.²⁰. Additionally, PBI membranes have low stability under high inlet stoichiometric flow rates, hence reducing the tolerance to higher CO concentrations in the inlet anode feed.

Ion-pair HT-PEMs based upon H₃PO₄ imbibed polycations (or polycation-PBI blends) have shown superior performance to PBI-H₃PO₄ as they are stable in the presence of water vapor (e.g., 40% RH at 80° C.) and at temperatures high as 240° C. while providing excellent proton conductivity (≥ 0.25 S cm⁻¹, ASR≤15 mΩ-cm²)^{15, 20}. The remarkable performance of the ion-pair HT-PEMs is attributed to cation moieties in the polymer host that anchor phosphate anions and mitigate H₃PO₄ loss from the polymer under challenging conditions, and the cation moieties spurring greater hydrogen bonding frustration of the imbibed H₃PO₄ that fosters proton conduction. Recently, we showcased the advancement of hydrogen reaction kinetics and gas permeability using phosphonic acid functionalized polymer electrolytes, poly(tetrafluorostyrene phosphonic acid-co-pentafluorstyrene) (PTFSPA) compared to conventional phosphoric acid imbibed polymer electrolytes. Pairing the ion-pair HT-PEMs with electrodes that feature poly(tetrafluorostyrene phosphonic acid-co-pentafluorstyrene) (PTFSPA) ionomer binders resulted in remarkable fuel cell performance²¹—e.g., power density up to 1.7 W cm⁻². Mixing the PTFSPA with Nafion as the electrode binder resulted in a fuel cell peak power density 2 W cm⁻² at 200° C. with hydrogen and oxygen²².

This example demonstrates a EHP for purifying hydrogen to +99.3% from reformed hydrocarbon mixtures (e.g., gases that contain 3%, 25%, and 40% CO) and water gas shift (WGS) reactor effluent mixtures (20 ppm CO). The EHP used an ion-pair HT-PEM and PTFSA electrode binders. The polarization behavior HT-EHPs were tested at high temperatures from 160° ° C. to 220° C. with 0% RH. The work is motivated by the fact that 90% of hydrogen today is attained from steam reforming methane found in natural gas leading to sizeable CO concentration (often over 20 mol %). The advent of ion-pair HT-PEMs and PTFSPA ionomer electrode binders that have thermal stability at temperatures up to 250° C., it was posited that a HT-PEM EHP can be operated at temperatures greater than 200° C. for the first time curtailing CO adsorption on the platinum electrocatalyst that hinders EHP performance. At 220° C., CO impact on EHP cell polarization was minimized and the polarization of the EHP cell was governed by the hydrogen concentration in the anode feed. Furthermore, hydrogen purity (HP), hydrogen recovery rate (HRR), power consumption, and power efficiency of syngas mixtures and WGS effluents were tested. The EHP featuring the ion-pair HT-PEM and PTFSA electrode binders had HP of greater than 99.3% with greater than 93% HRR in separating syngas and WGS effluents at 200° C. The ion-pair HT-PEM and PTFSPA electrode binders was stable for 100 hours at 200° C. for purifying hydrogen from syngas at 0.25 A cm⁻² with 12 u V h-1 of potential loss.

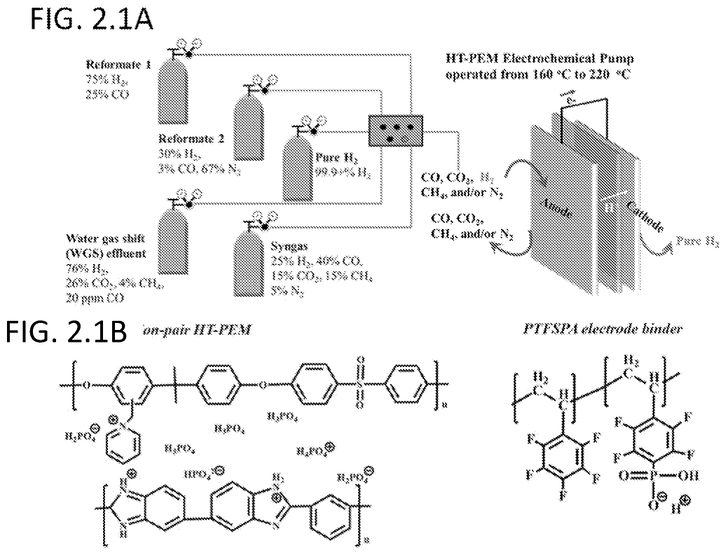

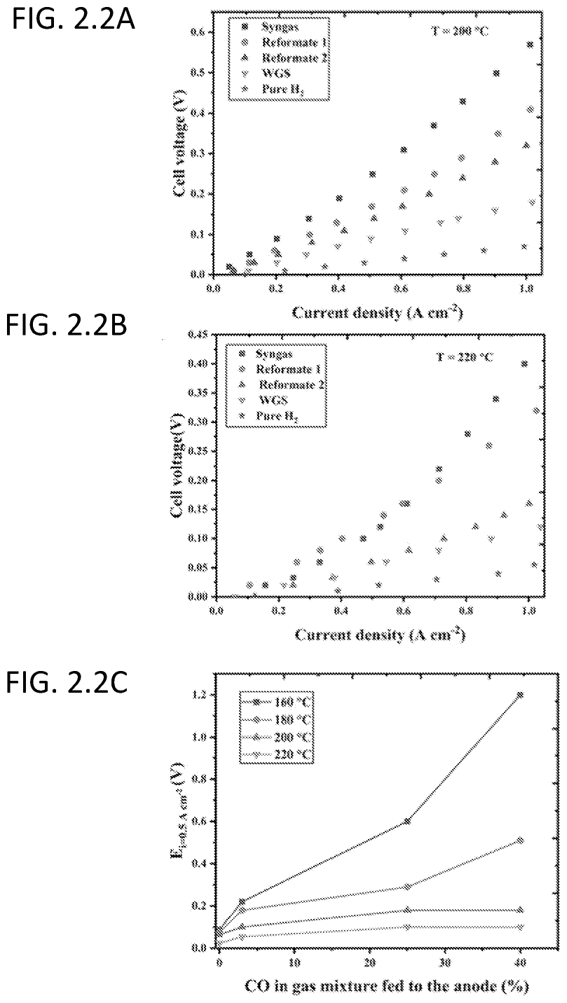

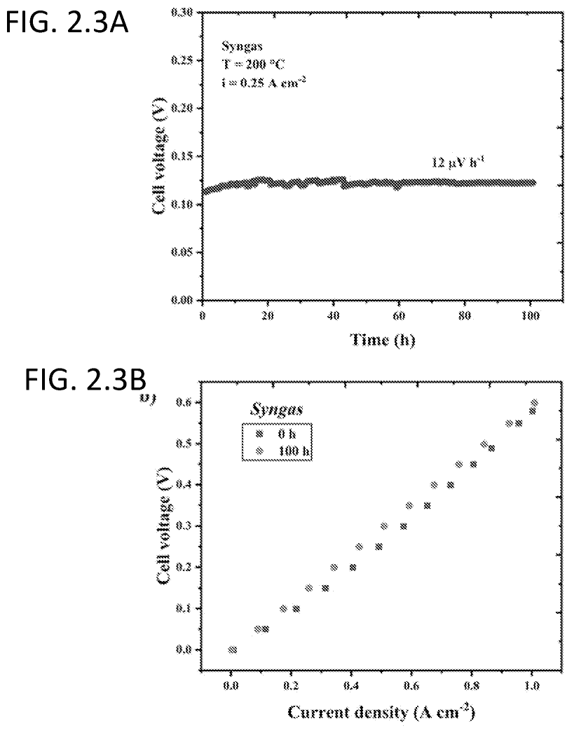

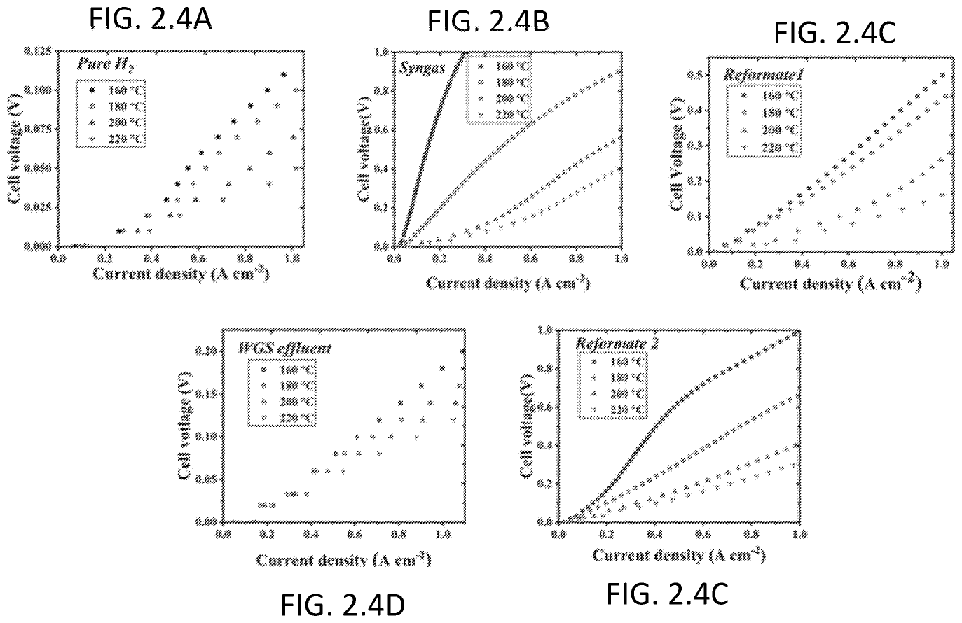

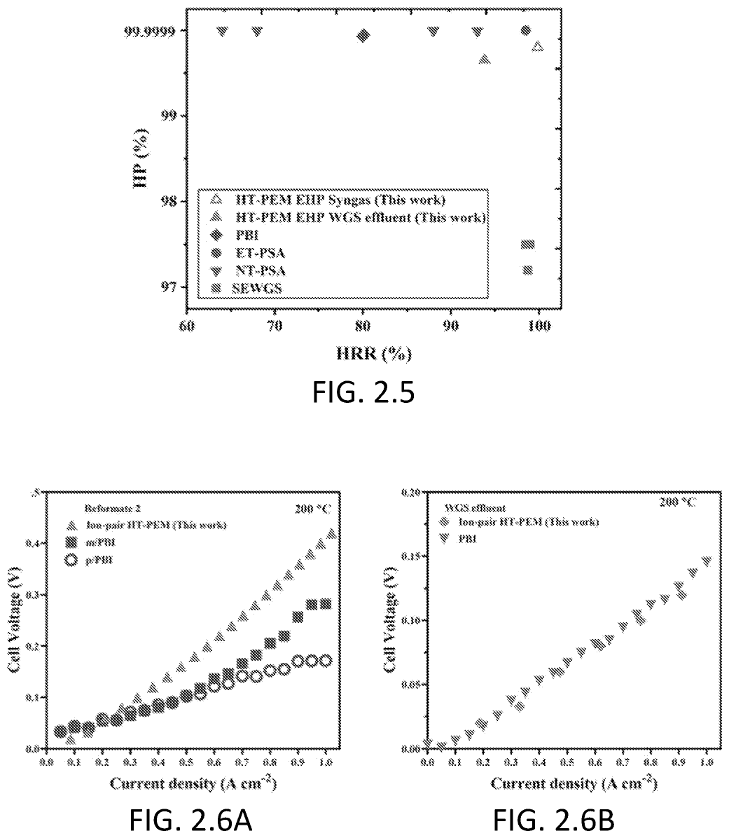

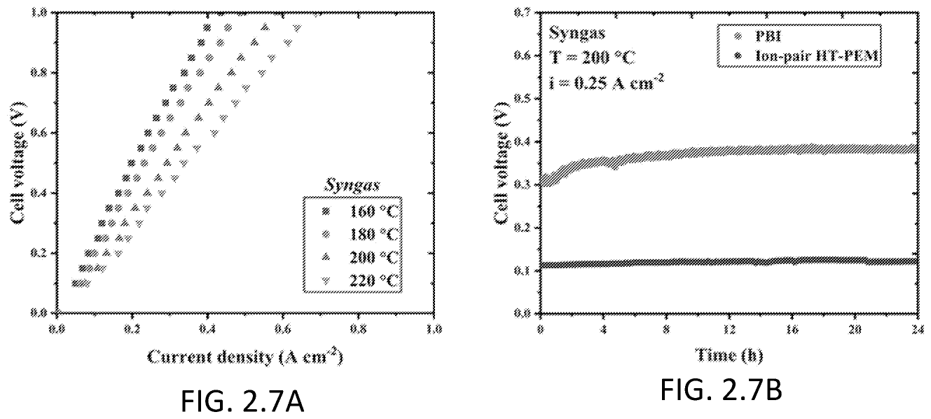

FIG. 2.1A depicts the experimental setup of several gas mixtures containing hydrogen plumbed to a single-cell HT-PEM EHP unit. The four gas mixtures were: i.) syngas (25% H_{2, 40}% CO, 15% CO₂, 15% CH₄, and 5% N₂), ii.) reformate 1 (75% H₂, and 25% CO), iii.) reformate 2 (30% H₂, 3% CO with N₂ balance), and iv.) water-gas shift (WGS) effluent (76% H_{2, 20}% CO₂, 5% CH₄, and 20 ppm CO). EHP performance with the various gas mixtures is benchmarked against pure hydrogen data from our previous work²³. Model reformate mixture compositions, reformate 1 and reformate 2, were selected based upon literature precedent^{18, 24}. These mixtures represent compositions from reformed methanol or other hydrocarbons. The syngas mixture used in this work is a challenging mixture for hydrogen separations using EHP because of the large CO content (in this case 40%). However, most of global hydrogen demand is satisfied from SMR; and thus, the separation platform for purifying hydrogen needs to tolerate sizeable CO concentrations. To deal with the CO, a WGS reactor is often employed to oxidize the CO to CO₂—a species that interferes less with platinum electrocatalysts and less toxic. In this work, we show that the HT-PEM EHP can purify hydrogen from each of these gas mixtures to >99.3% and with a hydrogen recovery rate over 93%. Adoption of materials that enable higher temperature operation (e.g., 200-220° C.) substantially reduces the polarization for separation and enables higher current density operation (i.e., a greater flux of purified hydrogen).

The chemical structures of the ion-pair HT-PEM and ionomer electrode binder used in the EHP are shown in FIG. 2.1B. The HT-PEM is quaternary benzyl pyridinium poly(arylene ether sulfone) blended with PBI imbibed with H₃PO₄ (QPPSf-PBI H₃PO₄). In our previous work²⁰, this HT-PEM displayed high proton conductivity (>250 mS cm⁻¹) and stability at 220° C. The PTFSPA binder does not contain any liquid acid and demonstrates proton conductivity of 2 mS cm⁻¹ without activation²³. Activating this material with a small amount of H₃PO₄ enhances its conductivity to 60 mS cm⁻¹. The gas diffusion electrodes (GDEs) used in the EHP feature platinum nanoparticles decorated on high surface area graphitic carbon with PTFSPA binder. The platinum loading in the anode and cathode was 1 mg_{Pt} cm⁻². This platinum loading is identical to other HT-PEM EHP reports that use BASF electrodes^{17, 18}.

FIGS. 2.4A-2.4E correspond to the steady-state EHP polarization curves with different hydrogen gas mixtures (or pure hydrogen) at 160° C., 180° C., 200° ° C., and 220° C. In each of these Figures, the polarization was reduced when moving the cell temperature from 160° C. to 220° C. The reduction in polarization was more prominent for the gas mixtures that contained 25% to 40% CO (e.g., reformates 1 and syngas). For the syngas feed that contained 40% CO, the EHP with the ion-pair HT-PEM and GDEs with PTFSPA binders operated at 1 A cm⁻² at 0.4 V when the cell temperature was 220° C. Temperature had a big impact on EHP performance—especially with syngas feds. The cell voltage was reduced by 0.97 V when moving the cell temperature from 160° C. to 220° C. when fixing the cell at 0.3 A cm⁻². The same increase in cell temperature for purifying hydrogen from reformates 1 at 0.5 A cm⁻² resulted in cell voltage drop of 0.2 V. The reduction in polarization for syngas at temperatures greater than 200° ° C. could be attributed to: i.) higher proton conductivity of the PTFSPPA and HT-PEM materials e, ii.) greater hydrogen diffusivity across the PTFSPA electrode ionomer binder that covers the electrocatalyst, iii.) and reduced CO adsorption on Pt leading, and iv.) improved HOR/HER kinetics.

Concentration of hydrogen in the gas mixture fed to the anode also had a profound impact on polarization. FIGS. 2.2A and 2.2B compare the polarization curves for the various gas mixtures at 220° C. and 200° C., respectively. Interestingly, the syngas and reformate 2 curves in FIG. 2.2A almost overlap at 220° C. despite the syngas having 13× more CO (40% versus 3% in reformate 2). Similarly, the traces in FIG. 2.2A for reformate 1 and WGS effluent practically overlapped too even though reformate 1 has a significant more CO (25% versus 0.02%). It is important to note that the hydrogen concentrations of syngas and reformate 2 range from 25% to 30% and their polarization curves are close to each other. Similarly, the hydrogen concentrations for reformate 1 and WGS effluent range from 75% to 76% and their polarization curves are about the same. FIG. 2.2A conveys that polarization behavior is a stronger function of hydrogen content in the gas mixture and that CO has a small impact on polarization. For the data sets at the next lowest temperature (i.e., 200° C.), there is greater separation between syngas and reformate 2 and WGS effluent and reformate 1 because there is more CO in syngas than reformate 2 and more CO in reformate 1 than WGS effluent. The salient observations from FIGS. 2.2A and 2.2B signal the following: i.) operating the HT-PEM EHP at 220° C. minimizes the impact CO has on EHP performance and ii.) EHP polarization is a strong function of the hydrogen content in the mixture. With respect to point ii.), Nguyen²⁵ observed a relationship between low-temperature PEM EHP polarization and hydrogen content in the anode feed (balanced by argon gas). Greater EHP polarization with lower hydrogen content in the anode is attributed to increase in the Nernstian potential in addition to larger concentration overpotential and activation overpotential values. Furthermore, the lower partial pressure of hydrogen in the anode causes greater mass transfer resistance and leads to a lower hydrogen permeability across the ionomer binder. The exchange current density is a function of the concentration of the reactant at the electrocatalyst surface, and thus lower hydrogen content in the bulk will lower the exchange current density and increase the activation overpotential.

To reinforce the observations from FIGS. 2.2A and 2.2B, FIG. 2.2C plots the cell voltage at 0.5 A cm⁻² versus CO concentration in the mixture for different cell temperatures. Driving the cell temperature from 160° C. to 220° C. flattens the cell voltage values across the different CO concentration values. Increasing the cell temperature reduces the propensity of CO to adsorb on the PGM surface in the anode and to block catalyst sites for HOR. FIGS. 2.2A-2.2C convey that increasing the cell temperature from 160° C. to 220° C. minimized the impact CO had on EHP polarization.

Table 1 demonstrates that over 99.3% hydrogen gas is generated at the cathode for each gas mixture. For the challenging syngas separation, only 0.3% CO showed up in the cathode effluent despite 40% CO being present in the anode gas stream. The composition of the cathode effluent was examined at two different steady-state current density values (0.25 A cm⁻² and 1 A cm⁻²). The current density had a negligible effect on the cathode composition. Overall, the HT-PEM was a good barrier to contaminants and fostered over 99% pure at the cathode. Table 2 presents the hydrogen recovery rate (HRR), power efficiency, and power consumption from HT-PEM EHP experiments with different hydrogen gas mixtures at 200° C. and at two different steady-state current density values (0.25 A cm⁻² and 1 A cm⁻²). This data was analyzed at T-200° ° C. for comparing against other EHP data in the literature^{17, 18}. The large power efficiency (%) of the HT-PEM EHP is attributed to the reduction in CO adsorption and improved HOR/HER kinetics at 200° C. HRR, power efficiency, and power consumption were calculated using Equations S1-S3. Most literature data for HRR and HP are for purifying hydrogen from WGS effluents and using pressure swing adsorption (PSA) and EHP units. FIG. 2.5 compares the HRR and HP data from this work against other peer-reviewed literature data^{17, 26-34}. The ion-pair HT-PEM EHP in this work represents the largest HRR value to date (98.84%). It is important to note that the data analyses were performed at 200° C. because the QPPSf-PBI H₃PO₄ ion-pair HT-PEM experiences a mechanical failure under compression at 220° C. within 30 hours²⁰ and other data in the literature for benchmarking is only available at 200° C. The ion-pair HT-PEM was shown to be previously stable in the temperature range of 180° ° C. to 200° ° C. for over 80 hours in a fuel cell device²⁰.

TABLE 1
Cathode effluent gas compositon at 200° C. from EHP experiments

| Gas mixtures | Syngas | | Reformate 1 | | WGS | | Reformate 2 | |
|---|---|---|---|---|---|---|---|---|
| Current density | 0.25 | 1 | 0.25 | 1 | 0.25 | 1 | 0.25 | 1 |
| (A cm⁻²) | | | | | | | | |

Cathode outlet composition

| | | | | | | | | |
|---|---|---|---|---|---|---|---|---|
| H₂ (%) | 99.36 | 99.65 | 99.75 | 99.84 | 99.40 | 99.80 | 99.78 | 99.85 |
| CO (%) | 0.300 | 0.205 | 0.25 | 0.16 | 0.0002 | 0.0025 | 0.006 | 0.003 |
| CO₂ (%) | 0.288 | 0.145 | — | — | 0.339 | 0.199 | — | — |
| N₂ (%) | 0.007 | 0.005 | — | — | 0.008 | 0.003 | 0.378 | 0.108 |
| CH₄ (%) | 0.051 | 0.032 | — | — | 0.09 | 0.07 | — | — |

TABLE 2
Hydrogen recovery rate (HRR), power efficiency, and power consumption for purifying
hydrogen from various gas mixtures using the HT-PEM EHP at T = 200° C.

| Gas mixtures | Syngas | | Reformate 1 | | WGS | | Reformate 2 | |
|---|---|---|---|---|---|---|---|---|
| Current density (A cm⁻²) | 0.25 | 1 | 0.25 | 1 | 0.25 | 1 | 0.25 | 1 |
| Hydrogen recovery rate (%) | 85.49 | 93.80 | 89.66 | 95.43 | 93.74 | 98.84 | 93.16 | 96.73 |
| Power efficiency (%) | 85.63 | 95.14 | 89.82 | 96.41 | 93.81 | 99.13 | 93.24 | 97.33 |
| Power consumption (mW cm⁻²) | 15.5 | 543 | 17.4 | 387 | 6.73 | 115 | 9.16 | 237 |

FIG. 2.6 compares EHP polarization data attained from this work against literature data using a PBI-type separator when purifying hydrogen from reformate 2 and WGS reactor effluent. These gas streams contain 3% CO and 20 ppm CO, respectively. The EHP with the ion-pair HT-PEM and GDEs with PTFSPA binders matched the polarization with state-of-the-art data with a WGS reactor effluent.

Because there are no other HT-PEM EHP studies with ion-pair HT-PEM separators for purifying hydrogen from gas mixtures containing CO over 3%, FIG. 2.7A compares the HT-PEM EHP polarization data from this work with syngas against polarization data with a Celazole® PBI HT-PEM separators at 200° C. Fumatech PBI separators are no longer commercially available. The Celazole® PBI separator was prepared from a dispersion that was attained from PBI Performance Products. Compared to the ion-pair HT-PEM, more cell polarization was observed with the PBI HT-PEM highlighting the superiority of the ion-pair HT-PEM for EHPs. At 0.5 A cm⁻² and 220° C., the cell voltage was 600 mV lower with the ion-pair HT-PEM when compared to the PBI HT-PEM. The electrodes were identical for these experiments. The greater polarization with the PBI separator was attributed to its higher area specific resistance (ASR) when compared to the ion-pair HT-PEM (0.23 Ω-cm² versus 0.02 Ω-cm²).

FIG. 2.3A reports the change in cell voltage at 200° ° C. for 100 hours with a steady-state current hold of 0.25 A cm⁻² and syngas feed to the anode. The HT-PEM EHP with ion-pair HT-PEM and PTFSA electrode binder only displayed an increase in 12 μV h-1. During the stability test, it was attempted to perform simultaneous compression and separation for hydrogen. The cathode back pressure was 207 kPa higher than the anode. However, the low gas flowrate on the cathode made it difficult to sustain differential pressure and thus the back pressure was lost at the 42 hour time point. Future work will focus on modifying the hardware and setup for simultaneous separation and compression without the addition of a carrier gas at the cathode that would dilute the hydrogen. FIG. 2.7B compares the HT-PEM EHP stability using an ion-pair HT-PEM separator and PBI HT-PEM separator at 200° C. The MEA with the PBI HT-PEM had 3× higher cell voltage at 0.25 A cm⁻² initially and the cell voltage increased by 3 mV h-1 over 24 hours. The EHP with the ion-pair HT-PEM separator was more stable than the EHP with the Celazole® PBI HT-PEM separator.

The purity of the hydrogen emanating from the cathode during the 100 hour stability test with the ion-pair HT-PEM was monitored at the 40 hour time point and at the 100 hour time point. The purity values were 99.5% and 99.4% hydrogen, respectively, and the CO content in the cathode was under 0.27%. Table S1 provides the gas composition values collected at the different time points during the stability test. FIG. 2.3B compares the polarization curves attained before the stability test and after the 100 hour stability test. There is some performance loss after the stability test, but the average current density difference for a given cell voltage value is 0.045 A cm⁻²—a relatively small value given that up 1 A cm⁻² can be extracted from the cell.

In summary, FIGS. 2.3A and 2.3B demonstrate that the EHP featuring the ion-pair HT-PEM and PTFSPA electrode binder is stable at 200° ° C. for 100 hours with minimal performance loss of 12 μV h-1 in purifying hydrogen from syngas.

A EHP with an ion-pair HT-PEM separator and PTFSA binder in the gas diffusion electrodes purified hydrogen to 99.3% from syngas (25% H₂ and 40% CO) at 1 A cm⁻² with a cell voltage of 400 mV. The high current density operation of the EHP with the challenging gas feed was made by possible operating the EHP at 220° C. This is the first demonstration showing that electrochemical pumping can be used to purify hydrogen from gas mixtures containing large CO concentrations at intermediate temperatures and at high current density values. The only other report³⁵ on EHP for purifying hydrogen from syngas (64% H_{2, 32}% CO, and 4% N2) required 800° C. operation because it used an inorganic solid electrolyte that has poor conductivity. Additionally, the HRR for purifying hydrogen to 99.3% from syngas was 85% HRR making the EHP a competitive platform for hydrogen separations from gas mixtures containing large CO concentrations. Finally, the HT-PEM was stable at 100 hours for purifying syngas at 200° ° C. while only experiencing a minor loss in performance (e.g., 12 μV h-1 increase under constant current operation). The ability of HT-PEM EHP to carry out challenging hydrogen separations with syngas and reformates opens future opportunities to convert methane in natural gas to pure hydrogen without using a WGS reactor for various downstream processes such as powering fuel cells, manufacturing chemicals, and refining metals. Additionally, the HT-PEM EHP demonstrated here can be useful for purifying hydrogen from gasified biomass.

### Supporting Information

Experimental materials and methods, steady-state polarization curves as function of temperature (160° ° C. to 220° C.) for HT-PEM EHP for the different gas mixtures fed to the anode, HP versus HRR for HT-PEM EHP, normal temperature PSA (NT-PSA), elevated temperature PSA (ET-PSA), and sorption enhanced WGS (SEWGS) technologies, HT-PEM EHP performance comparison for ion-pair HT-PEM (this work) and PBI separator, steady-state polarization curves as function of temperature for PBI HT-PEM and PTFSPA ionomer binder EHP for syngas, HT-PEM EHP stability test comparison for ion-pair HT-PEM (this work) and PBI at 200° ° C. and a constant current of 0.25 A cm⁻² with a syngas feed to the anode, and cathode effluent gas composition measured during the 100 hr stability test with syngas at 200° ° C. and a constant current of 0.25 A cm⁻².

### REFERENCES FOR EXAMPLE 2

(1) Peplow, M. How fracking is upending the chemical industry. Nature 2017, 550 (7674), 26-28. Deutch, J. The Revolution in Natural Gas. Perspectives on Complex Global Challenges: Education, Energy, Healthcare, Security and Resilience 2016, 81-83.
(2) McGrath, G. Electric power sector CO2 emissions drop as generation mix shifts from coal to natural gas. U.S. Energy Information Administration, 2021. https://www.eia.gov/todayinenergy/detail.php?id=48296
(3) Whitehouse.gov. FACT SHEET: President Biden Sets 2030 Greenhouse Gas Pollution Reduction Target Aimed at Creating Good-Paying Union Jobs and Securing U.S. Leadership on Clean Energy Technologies 2021. https://www.whitehouse.gov/briefing-room/statements-releases/2021/04/22/fact-sheet-president-biden-sets-2030-greenhouse-gas-pollution-reduction-target-aimed-at-creating-good-paying-union-jobs-and-securing-u-s-leadership-on-clean-energy-technologies/
(4) Whitehouse.gov. FACT SHEET: President Biden Sets 2030 Greenhouse Gas Pollution Reduction Target Aimed at Creating Good-Paying Union Jobs and Securing U.S. Leadership on Clean Energy Technologies 2021. https://www whitehouse gov/briefing-room/statements-releases/2021/04/22/fact-sheet-president-biden-sets-2030-greenhouse-gas-pollution-reduction-target-aimed-at-creating-good-paying-union-jobs-and-securing-u-s-leadership-on-clean-energy-technologies/
(5) Cullen, D. A.; Neyerlin, K. C.; Ahluwalia, R. K.; Mukundan, R.; More, K. L.; Borup, R. L.; Weber, A. Z.; Myers, D. J.; Kusoglu, A. New roads and challenges for fuel cells in heavy-duty transportation. Nature Energy 2021, 6, 462-474.
(6) Hydrogen Production: Natural Gas Reforming. U.S. Department of Energy, Hydrogen and Fuel Cell Technologies Office, https://www energy. gov/eere/fuelcells/bydrogen-production-natural-gas-reforming
(7) Ramachandran, R.; Menon, R. K. An overview of industrial uses of hydrogen. International Journal of Hydrogen Energy 1998, 23 (7), 593-598.
(8) Du, Z.; Liu, C.; Zhai, J.; Guo, X.; Xiong, Y.; Su, W.; He, G. A Review of Hydrogen Purification Technologies for Fuel Cell Vehicles. Catalysts 2021, 11 (3), 393.
(9) Aasadnia, M.; Mehrpooya, M.; Ghorbani, B. A novel integrated structure for hydrogen purification using the cryogenic method. Journal of Cleaner Production 2021, 278, 123872.
(10) Dunikov, D.; Blinov, D. Extraction of hydrogen from a lean mixture with methane by metal hydride. International Journal of Hydrogen Energy 2020, 45 (16), 9914-9926.
(11) Sircar, S.; Golden, T. C. Purification of Hydrogen by Pressure Swing Adsorption. Separation Science and Technology 2000, 35 (5), 667-687.
(12) Rahimpour, M. R.; Samimi, F.; Babapoor, A.; Tohidian, T.; Mohebi, S. Palladium membranes applications in reaction systems for hydrogen separation and purification: A review. Chemical Engineering and Processing: Process Intensification 2017, 121, 24-49.
(13) Fishel, K.; Qian, G.; Eisman, G.; Benicewicz, B. C. Electrochemical Hydrogen Pumping. In High Temperature Polymer Electrolyte Membrane Fuel Cells, Li, Q. Ed.; Springer International Publishing, 2016; pp 527-540.
(14) Maget, H. Process for gas purification. U.S. Pat. No. 3,489,670A 1964.
(15) Lee, K.-S.; Spendelow, J. S.; Choe, Y.-K.; Fujimoto, C.; Kim, Y. S. An operationally flexible fuel cell based on quaternary ammonium-biphosphate ion pairs. Nature Energy 2016, 1 (9), 16120.
(16) Jackson, C.; Raymakers, L. F. J. M.; Mulder, M. J. J.; Kucernak, A. R. J. Assessing electrocatalyst hydrogen activity and CO tolerance: Comparison of performance obtained using the high mass transport floating electrode technique and in electrochemical hydrogen pumps. Applied Catalysis, B: Environmental 2020, 268, 118734. Jackson, C.; Raymakers, L. F. J. M.; Mulder, M. J. J.; Kucernak, A. R. J. Poison mitigation strategies for the use of impure hydrogen in electrochemical hydrogen pumps and fuel cells. Journal of Power Sources 2020, 472, 228476.
(17) Huang, F.; Pingitore, A. T.; Benicewicz, B. C. High polymer content m/p-polybenzimidazole copolymer membranes for electrochemical hydrogen separation under differential pressures. Journal of the Electrochemical Society 2020, 167 (6), 63504.
(18) Huang, F.; Pingitore, A. T.; Benicewicz, B. C. Electrochemical Hydrogen Separation from Reformate Using High-Temperature Polybenzimidazole (PBI) Membranes: The Role of Chemistry. ACS Sustainable Chemistry & Engineering 2020, 8 (16), 6234-6242.
(19) Lee, A. S.; Choe, Y.-K.; Matanovic, I.; Kim, Y. S. The energetics of phosphoric acid interactions reveals a new acid loss mechanism. Journal of Materials Chemistry A 2019, 7 (16), 9867-9876.
(20) Venugopalan, G.; Chang, K.; Nijoka, J.; Livingston, S.; Geise, G. M.; Arges, C. G. Stable and Highly Conductive Polycation-Polybenzimidazole Membrane Blends for Intermediate Temperature Polymer Electrolyte Membrane Fuel Cells. ACS Applied Energy Materials 2020, 3 (1), 573-585.
(21) Atanasov, V.; Lee, A. S.; Park, E. J.; Maurya, S.; Baca, E. D.; Fujimoto, C.; Hibbs, M.; Matanovic, I.; Kerres, J.; Kim, Y. S. Synergistically integrated phosphonated poly(pentafluorostyrene) for fuel cells. Nature Materials 2021, 20 (3), 370-377.
(22) Lim, K. H.; Lee, A. S.; Atanasov, V.; Kerres, J.; Park, E. J.; Adhikari, S.; Maurya, S.; Manriquez, L. D.; Jung, J.; Fujimoto, C.; et al. Protonated phosphonic acid electrodes for high power heavy-duty vehicle fuel cells. Nature Materials 2022 (ASAP), https://doi.org/10.1038/s41560-021-00971-x
(23) Venugopalan, G.; Bhattacharya, D.; Kole, S.; Ysidron, C.; Angelopoulou, P. P.; Sakellariou, G.; Arges, C. G., Correlating high temperature thin film ionomer electrode binder properties to hydrogen pump polarization. Materials Advances 2021, 2, 4228-4234.
(24) Lee, K.-S.; Maurya, S.; Kim, Y. S.; Kreller, C. R.; Wilson, M. S.; Larsen, D.; Elangovan, S. E.; Mukundan, R. Intermediate temperature fuel cells via an ion-pair coordinated polymer electrolyte. Energy & Environmental Science 2018, 11 (4), 979-987.
(25) Nguyen, M. T.; Grigoriev, S. A.; Kalinnikov, A. A.; Filippov, A. A.; Millet, P.; Fateev, V. N. Characterisation of a electrochemical hydrogen pump using electrochemical impedance spectroscopy. Journal of Applied Electrochemistry 2011, 41 (9), 1033.
(26) Thomassen, M.; Sheridan, E.; Kvello, J. Electrochemical hydrogen separation and compression using polybenzimidazole (PBI) fuel cell technology. Journal of Natural Gas Science and Engineering 2010, 2 (5), 229-234.
(27) Wright, A. D.; White, V.; Hufton, J. R.; Quinn, R.; Cobden, P. D.; van Selow, E. R. CAESAR: Development of a SEWGS model for IGCC. 10th International Conference on Greenhouse Gas Control Technologies 2011, 4, 1147-1154.
(28) Allam, R. J.; Chiang, R.; Hufton, J. R.; Middleton, P.; Weist, E. L.; White, V.; Thomas, D. C. Chapter 13—Development of the Sorption Enhanced Water Gas Shift Process. Elsevier Science, 2005; pp 227-256.
(29) Wright, A.; White, V.; Hufton, J.; Selow, E. v.; Hinderink, P. Reduction in the cost of pre-combustion CO2 capture through advancements in sorption-enhanced water-gas-shift. Greenhouse Gas Control Technologies 9 2009, 1 (1), 707-714.
(30) Najmi, B.; Bolland, O.; Colombo, K. E. A systematic approach to the modeling and simulation of a Sorption Enhanced Water Gas Shift (SEWGS) process for CO2 capture. Separation and Purification Technology 2016, 157, 80-92.
(31) Ribeiro, A. M.; Grande, C. A.; Lopes, F. V. S.; Loureiro, J. M.; Rodrigues, A. E. Four beds pressure swing adsorption for hydrogen purification: Case of humid feed and activated carbon beds. AIChE Journal 2009, 55 (9), 2292-2302.
(32) Yang, S.-I.; Choi, D.-Y.; Jang, S.-C.; Kim, S.-H.; Choi, D.-K. Hydrogen separation by multi-bed pressure swing adsorption of synthesis gas. Adsorption 2008, 14 (4), 583-590.
(33) Luberti, M.; Friedrich, D.; Brandani, S.; Ahn, H. Design of a H₂ PSA for cogeneration of ultrapure hydrogen and power at an advanced integrated gasification combined cycle with pre-combustion capture. Adsorption 2014, 20 (2), 511-524.
(34) Zhu, X.; Shi, Y.; Li, S.; Cai, N. Two-train elevated-temperature pressure swing adsorption for high-purity hydrogen production. Applied Energy 2018, 229, 1061-1071.
(35) Matsumoto, H.; Okada, S.; Hashimoto, S.; Sasaki, K.; Yamamoto, R.; Enoki, M.; Ishihara, T. Hydrogen separation from syngas using high-temperature proton conductors. Ionics 2007, 13 (2), 93-99.

### Example 2 Supplemental Information

### Experimental

Materials—Polybenzimidazole (PBI) (10% in N,N-dimethylacetamide (DMAc)) from PBI Performance Products. Udel® poly(arylene ether sulfone) (PSf) resin with an average molecular weight (Mw) of 60 kDa from Acros Organics. Poly(pentafluorostyrene) (PPFS, average Mw=200 kDA) from Alfa Chemistry. Platinum nanoparticles on high surface area carbon supports (Pt/C, 37% Pt by weight) was attained from Tanaka Kikinzoku International (America), Inc. Porous carbon gas diffusion layers (GDLs) manufactured by AvCarb Materials Solutions were purchased from Fuel Cell Store. All other chemicals, pyridine, chlorotrimethylsilane, phosphoric acid (H₃PO₄, 85 wt % ortho-), reagent alcohol, paraformaldehyde, methanol, chloroform, deuterated chloroform (CDCl₃), dimethylsulfoxide (DMSO), and 2-propanol (IPA, >99.5%), were attained from VWR (either VWR or Acros Organics brand) and were used as is. All hydrogen containing gases were acquired from Airgas and used as is. These gases include: syngas (25% H₂, 40% CO, 15% CO₂, 15% CH₄, and 5% N₂), reformate 1 (75% H₂, and 25% CO), reformate 2 (30% H₂, 3% CO with N₂ balance), iv.) water-gas shift (WGS) effluent (76% H₂, 20% CO₂, 5% CH₄, and 20 ppm CO), and v.) pure hydrogen (ultra-high purity, 99.999%). The composition of the gases are expressed as mol %.

Synthesis of high-temperature polymer electrolyte membrane (HT-PEM)—The QPPSf-PBI H₃PO₄ HT-PEM was fabricated using same methodology reported in our previous work¹. To prepare the QPPSf-PBI membranes, 5 wt. % solution of chloromethylated polysulfone (CMPSf) in DMAc was blended with 5 wt. % solution of PBI in DMAc. CMPSf was synthesized via Friedel-Crafts alkylation of PSf using the procedures by Avram and co-workers², and as reported by us^{1, 3} and others⁴. The blended solutions were then sonicated for 30 minutes and then drop casted on a levelled glass plate in convection oven at 120° ° C. for 6 hours. The dried membranes were then peeled off and immersed in 1 M pyridine solution in reagent alcohol to convert the chloromethyl groups in the membrane to quaternary benzyl pyridinium chloride groups. The resulting membranes were washed with DI water and blot dried. The membranes were then immersed in 85 wt. % phosphoric acid (H₃PO₄) at 120° C. for 6 hours. The membranes were then blot dried to remove the excess acid. The thermal stability, ¹H NMR of QPPSf, ion-exchange capacity, in-plane proton conductivity, and mechanical properties of the QPPSf-PBI H₃PO₄ HT-PEMs were reported in our previous work¹. PBI HT-PEM was fabricated by drop casting 5 wt % PBI solution in DMAc at 120° C. for 6 hours. The dried membranes were then immersed in 85 wt. % phosphoric acid (H₃PO₄) at 40° C. for overnight. The resulting membranes were blot dried and used for MEA fabrication.

Synthesis of PTFSPA—The phosphonation of PPFS was carried out following the procedure reported by Atanasov et al.⁵ and reported in our previous work⁶. 1 g PPFS (5.2 mmol) was dissolved in 4 g of DMAc at room temperature in a round bottom flask equipped with magnetic stirrer, reflux condenser and an oil bath. The temperature was increased to 170° C. and tris(trimethylsilyl) phosphite (TSP, 1.07 g, 3.6 mmol) was added dropwise, and the reaction was carried out for 16 hours. The resulting polymer solution was poured into DI water and the white solid was precipitated. The white solid polymer was refluxed in DI water for 30 minutes, by changing fresh water every 10 minutes, followed by boiling in 2% H₃PO₄ solution and washing with DI water till a neutral pH was obtained. The PTFSPA was a white solid and was dried in a vacuum oven for 16 hours. The phosphonic acid tethered groups were confirmed via 31P NMR. A 70% degree of phosphonation was targeted by controlling the ratio of TSP to PPFS ratio. The resulting PTFSPA was dissolved in DMSO to make an ionomer solution (5 wt. %). The IEC of PTFSPA was 2.5 mmol g⁻¹ and was determined by base titration method as reported in our previous work⁷.

Preparation of GDEs and MEA fabrication—The catalyst inks for fabrication of GDEs were formulated by mixing 0.2 g of 37% Pt/C with 1.715 g of PTFSPA ionomer solution diluted with approximated 5.5 g of IPA. The prepared ink was sonicated for 30 minutes to provide a completely dispersed solution. The gas diffusion layers were then painted with the prepared catalyst inks using an aerosolized spray gun with nitrogen gas to make GDEs. The active area of the resultant GDE was 5 cm². The catalyst loading was measured gravimetrically by measuring the weight change before and after painting and drying. The catalyst loading for the anode GDE and cathode GDE were both 1 mg_{Pt} cm⁻² The weight fraction of the ionomer in the electrode layer was 30 wt. % but could be as low as 10 wt. %. A 5 cm² membrane electrode assembly (MEA) was prepared by sandwiching the ion-pair QPPSf-PBI H₃PO₄ HT-PEM with gas diffusion electrodes (GDEs). A similar procedure was adopted for PBI HT-PEM MEA with PTFSPA electrode binder. The MEA was assembled into Scribner Associates Inc. Fuel Cell Hardware that contained machined graphite flow fields, gold current collectors, and rubber and Teflon® gaskets. The hardware was plumbed to a 850 E Scribner Associates Inc. Fuel Cell Test Stand for temperature and mass flow control during EHP experiments. A custom made fiberglass covering was used for insulating the hardware and allowing high temperature operation up to 220° C.

Hydrogen separations with the EHP—For electrolytic driven hydrogen separations in the EHP, a Gamry 3000 AE potentiostat/galvanostat with a Gamry Current Booster was connected to the gold current collectors in the cell hardware. Before collecting polarization data and impedance spectra, the cell was allowed to reach 120° C. under nitrogen on both anode and cathode. The cell was heated further to 160° C. under pure hydrogen on the anode and no sweep gas at the cathode. The polarization curves were attained for pure hydrogen at 160° ° C., 180° C., 200° C., and 220° C. by performing linear sweep voltammetry (LSV) at 20 mV s-1 scan rate. Then, the cell was cooled and then a different gas mixture was fed to the anode and polarization curves were collected at the same temperature values. This procedure was repeat for each of the different gas mixtures. All the polarization experiments were performed under atmospheric conditions without any backpressure—unless specified otherwise. It is also important to note that electrochemical impedance spectroscopy (EIS) was collected at each cell temperature and gas feed to the anode prior to collecting the polarization curve. EIS was performed from 100 kHz to 10 Hz with a 1 mA perturbation. No background current was applied during EIS experiments. The Nyquist plots from EIS identified the high-frequency resistance value. This value was used to determine the area specific resistance for the current distribution model.

Gas composition determination—The flow from the cathode outlet was collected using a gas chromatography bag. The composition of the gas was determined using Agilent 490 micro-gas chromatograph (GC) using Argon as the carrier gas. Calibration curves for the individual species were generated using measurements from runs with two standard calibration gases obtained from Shimadzu. The first calibration gas contained 400 ppm carbon dioxide, 100 ppm ethylene, 100 ppm ethane, 100 ppm methane, 100 ppm carbon monoxide, 100 ppm hydrogen, 2500 ppm oxygen and 16900 ppm nitrogen in argon; the second calibration gas contained 2% carbon dioxide, 0.42% ethylene, 0.42% ethane, 0.42% methane, 0.42% carbon monoxide, 0.42% hydrogen and 12.5% oxygen in nitrogen. Calibration gases were run 3 times each and the peak area for each species averaged. Concentration was plotted against peak area and a linear trendline fit to the two points.

Hydrogen recovery rate, power efficiency, and power consumption of EHS using different hydrogen mixtures—Hydrogen recovery rate is the fraction of hydrogen produced in the cathode (F_{H}_{₂}_{,out}) compared to the fraction of hydrogen consumed in the anode (F_{H}_{₂}_{,in}) as shown in Equation S1. F_{H}_{₂}_{,in} was calculated based on the current supplied (i_{applied}) in the anode. F_{H}_{₂}_{,out} was calculated based on the current utilized in oxidizing H₂ in the cathode using the cell voltage observed at the current supplied and the resistance (high frequency resistance (HFR)) for protons to permeate through the membrane to reach the cathode measured using high frequency resistance from electrochemical impedance spectroscopy (EIS) measurements. The frequency range was set to 100,000 to 1 Hz with an oscillatory amplitude of 0.01 mA at different current densities.

$$Hydrogen recovery {rate ( HRR )}^{7} = \frac{{F}_{{H}_{2} , out}}{{F}_{{H}_{2} , in}} \qquad ( S1 )$$

$${F}_{{H}_{2} , in} = \frac{{i}_{applied}}{nF} ; {F}_{{H}_{2} , out} = \frac{( V / R )}{nF}$$

where i_{applied} is the current applied in the anode, V is the cell voltage at the applied current (i_{applied}), R is the HFR measured from EIS, n is the number of electrons generated in reducing hydrogen, and F is Faraday's constant (96500 C mol-1).

Power efficiency is the net energy revered (the energy contained in the purified hydrogen minus the power consumed from the external system) to the total energy contained in the anode hydrogen feed. Power efficiency of EHP is calculated using Equation S2.

$$Power {efficiency}^{7} = \frac{{F}_{{H}_{2} , out} Δ {H}_{combustion} - {i}_{applied} V}{{F}_{{H}_{2} , in} Δ {H}_{combustion}} \qquad ( S2 )$$

where ΔH_{combustion} is the enthalpy of combustion of hydrogen. Power consumption is the power density consumed from the external system to separate hydrogen from the mixtures and is calculated using Equation S3.
Power Consumption=i_{applied} V

### (S3)

Stability testing—The 100 hour stability test using syngas was performed at 200° C. and at a constant current of 0.25 A cm⁻². The effluent from the cathode was collected in GC bags within the first 30 minutes, the 40 hour time point and 100 hour time point. The composition of the cathode effluent was measured using the Agilent 490 micro-GC. The stability test commenced under 207 kPa of cathode back pressure, but this back pressure was lost at 42 hours due to the low gas flowrate. The stability test continued with no back pressure on the cathode for the final 58 hours.

TABLE S1
Cathode effluent gas composition measured during the
100 hr stability test with syngas at 200° C. and a constant
current of 0.25 A cm⁻².

| Time (h) | H₂ (%) | CO (%) | CO₂ (%) | N₂ (%) | CH₄ (%) |
|---|---|---|---|---|---|
| 0 | 99.65 | 0.205 | 0.145 | 0.007 | 0.051 |
| 40 | 99.52 | 0.243 | 0.173 | 0.01 | 0.054 |
| 100 | 99.47 | 0.262 | 0.199 | 0.012 | 0.057 |

### REFERENCES OF SUPPLEMENTAL INFORMATION FOR EXAMPLE 2

(1) Venugopalan, G.; Chang, K.; Nijoka, J.; Livingston, S.; Geise, G. M.; Arges, C. G. Stable and Highly Conductive Polycation-Polybenzimidazole Membrane Blends for Intermediate Temperature Polymer Electrolyte Membrane Fuel Cells. ACS Applied Energy Materials 2020, 3 (1), 573-585.
(2) Avram, E.; Butuc, E.; Luca, C.; Druta, I. Polymers with pendant functional group. III. Polysulfones containing viologen group. J. Macromol. Sci., Pure Appl. Chem. 1997, A34 1701-1714.
(3) Arges, C. G.; Parrondo, J.; Johnson, G.; Nadhan, A.; Ramani, V. Assessing the influence of different cation chemistries on ionic conductivity and alkaline stability of anion exchange membranes. Journal of Materials Chemistry 2012, 22 (9), 3733-3744.
(4) Gu, S.; Cai, R.; Luo, T.; Chen, Z.; Sun, M.; Liu, Y.; He, G.; Yan, Y. A soluble and highly conductive ionomer for high-performance hydroxide exchange membrane fuel cells. Angew. Chem., Int. Ed. 2009, 48, 6621-6624.
(5) Atanasov, V.; Kerres, J. Highly Phosphonated Polypentafluorostyrene. Macromolecules 2011, 44 (16), 6416-6423. Atanasov, V.; Oleynikov, A.; Xia, J.; Lyonnard, S.; Kerres, J. Phosphonic acid functionalized poly(pentafluorostyrene) as polyelectrolyte membrane for fuel cell application. Journal of Power Sources 2017, 343, 364-372.
(6) Venugopalan, G.; Bhattacharya, D.; Kole, S.; Ysidron, C.; Angelopoulou, P. P.; Sakellariou, G.; Arges, C. G. Correlating high temperature thin film ionomer electrode binder properties to hydrogen pump polarization. Materials Advances 2021, 2, 4228-4234.
(7) Huang, F.; Pingitore, A. T.; Benicewicz, B. C. Electrochemical Hydrogen Separation from Reformate Using High-Temperature Polybenzimidazole (PBI) Membranes: The Role of Chemistry. ACS Sustainable Chemistry & Engineering 2020, 8 (16), 6234-6242.
(8) Huang, F.; Pingitore, A. T.; Benicewicz, B. C. High polymer content m/p-polybenzimidazole copolymer membranes for electrochemical hydrogen separation under differential pressures. Journal of the Electrochemical Society 2020, 167 (6), 63504.
(9) Thomassen, M.; Sheridan, E.; Kvello, J. Electrochemical hydrogen separation and compression using polybenzimidazole (PBI) fuel cell technology. Journal of Natural Gas Science and Engineering 2010, 2 (5), 229-234.
(10) Wright, A. D.; White, V.; Hufton, J. R.; Quinn, R.; Cobden, P. D.; van Selow, E. R. CAESAR: Development of a SEWGS model for IGCC. 10th International Conference on Greenhouse Gas Control Technologies 2011, 4, 1147-1154.
(11) Allam, R. J.; Chiang, R.; Hufton, J. R.; Middleton, P.; Weist, E. L.; White, V.; Thomas, D. C. Chapter 13—Development of the Sorption Enhanced Water Gas Shift Process. Elsevier Science, 2005; pp 227-256.
(12) Wright, A.; White, V.; Hufton, J.; Selow, E. v.; Hinderink, P. Reduction in the cost of pre-combustion CO2 capture through advancements in sorption-enhanced water-gas-shift. Greenhouse Gas Control Technologies 9 2009, 1 (1), 707-714.
(13) Najmi, B.; Bolland, O.; Colombo, K. E. A systematic approach to the modeling and simulation of a Sorption Enhanced Water Gas Shift (SEWGS) process for CO2 capture. Separation and Purification Technology 2016, 157, 80-92.
(14) Ribeiro, A. M.; Grande, C. A.; Lopes, F. V. S.; Loureiro, J. M.; Rodrigues, A. E. Four beds pressure swing adsorption for hydrogen purification: Case of humid feed and activated carbon beds. AIChE Journal 2009, 55 (9), 2292-2302.
(15) Yang, S.-I.; Choi, D.-Y.; Jang, S.-C.; Kim, S.-H.; Choi, D.-K. Hydrogen separation by multi-bed pressure swing adsorption of synthesis gas. Adsorption 2008, 14 (4), 583-590.
(16) Luberti, M.; Friedrich, D.; Brandani, S.; Ahn, H. Design of a H₂ PSA for cogeneration of ultrapure hydrogen and power at an advanced integrated gasification combined cycle witpre-combustion capture. Adsorption 2014, 20 (2), 511-524.
(17) Zhu, X.; Shi, Y.; Li, S.; Cai, N. Two-train elevated-temperature pressure swing adsorption for high-purity hydrogen production. Applied Energy 2018, 229, 1061-1071.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. In an embodiment, the term “about” can include traditional rounding according to significant figures of the numerical value. In addition, the phrase “about ‘x’ to ‘y’” includes “about ‘x’ to about ‘y’”.

It should be emphasized that the above-described embodiments of the present disclosure are merely possible examples of implementations, and are set forth only for a clear understanding of the principles of the disclosure. Many variations and modifications may be made to the above-described embodiments of the disclosure without departing substantially from the spirit and principles of the disclosure. All such modifications and variations are intended to be included herein within the scope of this disclosure.

1. An electrochemical hydrogen pump, comprising:
a first electrode coating disposed on a second side of a first substrate or on a first side of a high temperature polymer electrolyte membrane, wherein the second side of the first substrate opposes the first side of the high temperature polymer electrolyte membrane; and
a second electrode coating disposed on a second side of the high temperature polymer electrolyte membrane or on the second side of a second substrate, wherein the second side of the high temperature polymer electrolyte membrane opposes the second side of the second substrate,
wherein the first substrate has the characteristic of a porous gas diffusion layer that is conductive and serves as an anode and the second substrate has the characteristic of a porous gas diffusion layer that is conductive and serves as a cathode,
wherein the first electrode coating comprises a phosphonic acid ionomer without liquid and a plurality of catalyst particles,
wherein the second electrode coating comprises a phosphonic acid ionomer without liquid and a plurality of catalyst particles.

2. The electrochemical hydrogen pump of claim 1, wherein the phosphonic acid ionomer without liquid has the characteristic of a binder for the plurality of catalyst particles in the first electrode coating and the second electrode coating.

3. The electrochemical hydrogen pump of claim 1, wherein the phosphonic acid ionomer without liquid has a proton conductivity of greater than about 0.02 to 0.05 S cm⁻¹ at 200 to 220° C.

4. The electrochemical hydrogen pump of claim 1, wherein phosphonic acid ionomer without liquid has a gas permeability to H₂ gas permeability that is about 5× or more greater than a gas permeability to Ha for a phosphoric acid (H₃PO₄) imbibed quaternary benzyl pyridinium polysulfone (QPPSf) thin film polymer electrolyte.

5. The electrochemical hydrogen pump of claim 1, wherein the phosphonic acid ionomer without liquid is a phosphonic acid functionalized polypentafluorostyrene.

6. The electrochemical hydrogen pump of claim 1, wherein the phosphonic acid ionomer without liquid is poly(tetraflurostyrene phosphonic acid-co-pentafluorostyrene) (PTFSPA).

7. The electrochemical hydrogen pump of claim 1, wherein the catalyst is a carbon particle having platinum group metal particles disposed thereon, wherein the carbon particles have a diameter of about 100 nm to 2 μm and the platinum particles have a diameter of about 2 nm to 20 nm.

8. The electrochemical hydrogen pump in claim 1, wherein the high-temperature polymer electrolyte membrane is based upon phosphoric acid imbibed polycations or phosphoric acid imbibed polycations blended with polybenzimidazole and operates and conducts ions at temperature of −20 to 300° C.

9. The electrochemical hydrogen pump in claim 1, wherein the high-temperature polymer electrolyte membrane thickness can vary from 2 μm to 200 μm.

10. The electrochemical hydrogen pump in claim 1, wherein the electrochemical hydrogen pump is configured to produce 99.3% to 100% pure hydrogen at the cathode from a gas mixture fed to the anode.

11. The electrochemical hydrogen pump in claim 1, wherein the gas mixture is selected from model reformate mixtures: i.) model syngas composed of 25% hydrogen, 40% carbon monoxide, 15% carbon dioxide, 15% methane, and 5% nitrogen; ii.) reformate mixture with a smaller carbon monoxide content −30% hydrogen, 3% carbon monoxide, and 67% nitrogen; iii.) model water gas shift reaction effluent with 75% hydrogen, 20% carbon dioxide, 5% methane, and 20 ppm carbon monoxide; or iv.) a hydrocarbon reformate mixture with 75% hydrogen and 25% carbon monoxide.

12. The electrochemical hydrogen pump in claim 1, wherein the gas mixture comprises hydrogen in natural gas, wherein the electrochemical hydrogen pump is configured to generate 99 to 100% hydrogen at the cathode.

13. The electrochemical hydrogen pump in claim 1, wherein the electrochemical hydrogen pump is stable, voltage increase less than 15 μV/hr, at 200° C. for over 100 hours.

14. The electrochemical hydrogen pump in claim 1, wherein the electrochemical hydrogen pump operates at 160 to 300° C.

15. The electrochemical hydrogen pump in claim 1, wherein the width of the anode, the high temperature polymer electrolyte membrane, and the cathode is about 10 to 275 microns.

16. A method of producing, purifying, and/or compressing hydrogen gas, comprising:
introducing a gas mixture to the anode of the electrochemical hydrogen pump of claim 1, and generating hydrogen gas.

17. The method of claim 16, wherein the wherein the gas mixture is selected from model reformate mixtures: i.) model syngas composed of 25% hydrogen, 40% carbon monoxide, 15% carbon dioxide, 15% methane, and 5% nitrogen; ii.) reformate mixture with a smaller carbon monoxide content −30% hydrogen, 3% carbon monoxide, and 67% nitrogen; iii.) model water gas shift reaction effluent with 75% hydrogen, 20% carbon dioxide, 5% methane, and 20 ppm carbon monoxide; or iv.) a hydrocarbon reformate mixture with 75% hydrogen and 25% carbon monoxide.

18. The method of claim 16, wherein the gas mixture comprises hydrogen in natural gas, wherein the electrochemical hydrogen pump to generates 99% to 100% hydrogen at the cathode.

19. The method of claim 16, wherein the electrochemical hydrogen pump operates at 160 to 250° C.

20. The method of claim 16, wherein the electrochemical hydrogen pump operates at about 200° C.
